(19) United States
(12) Patent Application Publication
(10) Pub. No.: US 2021/0198583 A1
(43) Pub. Date: Jul. 1, 2021

(54) COMPOSITION AND METHOD FOR ELIMINATION OF HYDROGEN SULFIDE AND MERCAPTANS

(71) Applicant: Lyra Energy SRL, Christ Chruch (BB)

(72) Inventors: Konstantin Poukalov, SR., Sarasota, FL (US); Alexander Semenyuk, Moscow (RU); Kevin G. Liu, West Windsor, NJ (US)

(21) Appl. No.: 17/200,221

(22) Filed: Mar. 12, 2021

Related U.S. Application Data
(63) Continuation of application No. 16/624,444, filed on Dec. 19, 2019.

(30) Foreign Application Priority Data
Jun. 26, 2017 (RU) 2017122342

(51) Int. Cl. C10G 29/20

(52) U.S. Cl. CPC C10G 29/20; C10G 2300/207

(57) ABSTRACT

A scavenging composition and method for scavenging hydrogen sulfide and/or mercaptans from fluids. The scavenging composition comprises an alkali metal nitrite and a nitrogen-containing scavenger, and optionally an inorganic base, as a hydrogen sulfide and/or a mercaptan scavenger for hydrocarbon fluids, particularly for crude oil, field oil, fuel oil, straight run distillates, cracked distillates, residual fuels, natural gas, petroleum associated gas and the like.

### FIELD OF THE INVENTION

The present invention generally relates to compositions and methods for scavenging hydrogen sulfide and/or mercaptans from fluids. More particularly, the invention relates to the use of compositions comprising an alkali metal nitrite and a nitrogen-containing scavenger, and optionally an inorganic base, as a hydrogen sulfide and/or a mercaptan scavenger for hydrocarbon fluids, particularly for crude oil, field oil, fuel oil, straight run distillates, cracked distillates, residual fuels, natural gas, petroleum associated gas and the like.

### BACKGROUND

Hydrogen sulfide and/or volatile mercaptans (also known as thiols) are often encountered in drilling, downhole completion, production, transport, storage, and processing of crude oil and natural gas, including wastewater associated with crude oil and gas production, and in the storage of oil and residual fuel oil. The presence of hydrogen sulfide and/or mercaptans in crude oil, natural gas, crude petroleum gas or synthesis gas is undesirable for various reasons. Hydrogen sulfide and mercaptans are highly toxic and corrosive. They also have highly noxious odors and are very hazardous for human health and the environment. During combustion, oils or natural gases rich in hydrogen sulfide and/or mercaptans produce heavy environmental pollution owing to the resultant sulfur dioxide. In cracking plants, the hydrogen sulfide acts as a contact poison for the catalysts. Also, it leads to hydrogen-induced brittleness in carbon steels and to stress corrosion cracking in more highly alloyed materials. For the reasons mentioned, it has been attempted, as far as possible, to wash out, or chemically convert, the hydrogen sulfide and volatile mercaptans from the fossil oils and natural or petroleum gas.

Thus, there are various physical and chemical processes for the purification of crude oils and gases. Depending on the content of hydrogen sulfide and impurities in the crude oils and gases and the requirements for the purity of the final product, these processes are economical to varying degrees. The content of hydrogen sulfide and mercaptans in oil is in the ppm range, while hydrogen sulfide and mercaptans (predominantly hydrogen sulfide) can be present in natural gas at levels of 20% and more.

In large production facilities, an economical solution for removing hydrogen sulfide in the gas process stream is to install a regenerative-system-based amine solution as an absorbent. After absorbing the hydrogen sulfide, the amine solutions are then regenerated, usually by heating, and reused in the system. The separated hydrogen sulfide is typically treated via the Claus process to form elemental sulfur. Several types of amine solutions can be used as the absorbent depending on the sour gas specifications. Typical amines are: monoethanolamine (MEA); diethanolamine (DEA); N-methyldiethanolamine (MDEA); diisopropylamine; and diglycolamine (DGA), also known as 2-(2-aminoethoxy)ethanol. All of these amines presume large facilities for regeneration of absorbent and utilization of hydrogen sulfide in a Clause process plant. Thus, these technologies are designed for large-scale applications.

The use of aldehydes for scavenging hydrogen sulfide is also known in the art. For example, in U.S. Pat. No. 1,991,765, the reaction of hydrogen sulfide and an aldehyde in a wide pH range at temperatures of 20-100° C. is described. In particular, at pH values of 2 or less the reaction of formaldehyde, glyoxal, acrolein and other aldehydes is known (see, e.g., U.S. Pat. Nos. 2,606,873, 3,514,410, 3,585,069, 3,669,613, 4,220,500, 4,289,639, and 4,310,435).

In practice, formaldehyde solutions have primarily been employed to generate a water-insoluble trithiane product, and, as by-products, very unpleasant-smelling alkylmercaptans are formed (see, e.g., “H2S-Scavenging” in Oil and Gas Journal, January 1989, 51-55 (Part 1); 81-82 (Part 2); February 1989, 45-48 (Part 3); 90-91 (Part 4)). Trithiane deposits are hard to remove and under a change of pH may decompose into the starting materials. When using a scavenger based on formaldehyde, special safety precautions have to be taken due to the odor and the toxicity, both of hydrogen sulfide and of carcinogenic formaldehyde.

As a consequence of the disadvantages of formaldehyde, other aldehydes are increasingly being employed today. Glyoxal, in particular, has found its way into the oil and natural gas industry as a hydrogen sulfide scavenger. U.S. Pat. No. 4,680,127 describes a process for reducing the hydrogen sulfide content in aqueous or wet gaseous media by addition of small amounts of glyoxal or glyoxal in combination with other aldehydes. However, an essential disadvantage of this process is the addition products of glyoxal and hydrogen sulfide, which are formed in this case and may clog pipelines. In the acidic pH conditions typical in practice, these addition products are no longer stable and decompose with the release of hydrogen sulfide.

The general shortcoming of aldehydes is that they are not efficient to scavenge mercaptans. To overcome this and other shortcomings of aldehydes, other types of compositions have been employed. Frequently such compositions are reaction products of aldehydes and amine compounds, and may or may not contain one or more triazines or derivatives thereof. See, e.g., U.S. Pat. No. 5,698,171; Sullivan III, et al., U.S. Pat. Nos. 5,674,377, 5,674,377, and 5,744,024; Rivers, et al., U.S. Pat. No. 5,554,591; Weers, et al., U.S. Pat. Nos. 5,074,991, 5,169,411, 5,223,127, 5,266,185, 6,024,866, and 5,284,576; Pounds, et al., U.S. Pat. Nos. 5,462,721 and 5,688,478; Bhatia, et al., Canadian patents 2,125,513 and 2,148,849; and Callaway, U.S. Pat. No. 5,958,352. They may be contacted with the hydrocarbons in various ways as mentioned in these patents and others such as Galloway, U.S. Pat. No. 5,405,591, and Fisher, U.S. Pat. No. 6,136,282.

Many of the scavengers mentioned in the above cited patents remain, in one form or another, in the hydrocarbons they are used to treat. That is, they may be effective at suppressing the evolution of hydrogen sulfide and/or mercaptan, for example, but the undesirable reaction products are left in the hydrocarbon. Triazines cause reaction products that tend to polymerize, and form difficult-to-remove sedimentations, while products of amine scavengers are unstable and may easily reverse to hydrogen sulfide form.

In the reaction of hydrogen sulfide in oils by scavengers based on amine/formaldehyde derivatives, a range of organic sulfur compounds are formed, which are not naturally present in the native oil. These compounds are not removed during the preparation of oil at the field and at the refinery crude distillation unit (CDU), thus getting to the primary distillation unit they undergo thermal decomposition, forming, e.g., active volatile sulfur compounds that enter into reaction with metal hardware causing corrosion. Many refineries observe “atypical” cases of corrosion and the formation of large amounts of sediment in the sections of air coolers and reflux containers. This may be caused by the thermal degradation products of the interaction of hydrogen sulfide with scavengers based on amine/aldehyde derivatives.

Buffered aqueous solutions containing alkali metal nitrites may also be used in scrubber towers. Although effective, such systems produce elemental sulfur which cause corrosion and are limited in use to process gaseous streams only. An example of such a system is marketed by NL Industries under the name “SULFA-CHECK” and disclosed in U.S. Pat. No. 4,515,759. SULFA-CHECK is a buffered aqueous solution of sodium nitrite that is injected into scrubber towers to sweeten natural gas. Such nitrite-based sweetening materials are undesirable since, as noted above, they produce solids (i.e., corrosive elemental sulfur), which clogs the lines and causes problems for cleaning the inner space of the absorption column. Accordingly, such systems can not be used in “in-line” injection systems and may only be used in bubble towers.

Thus, there is a need for a method of hydrogen sulfide removal from hydrocarbon feedstock that does not form insoluble reaction products retained in the oil or form difficult-to-remove deposits in pipelines and reservoirs, and that not merely neutralizes the sulfur compounds, but enables the ready removal of them from the hydrocarbons in a form of spent solution with the produced waters. There is also a continuing need for a scavenging method which could simultaneously remove not only hydrogen sulfide, but also mercaptans, by converting them into the more acceptable form of disulfides, i.e., which could achieve the same result as is obtained with the use of the commercially proven process of Merox Sweetening, but without involving oxygen. Another continuing need in the industry is for a method that can carry out the scavenging at reduced environmental temperatures and within processing time constraints.

### SUMMARY

One embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite and at least one organic nitrogen-containing scavenger.

One embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite and at least one organic nitrogen-containing scavenger; wherein the aqueous solution comprises from 1 to 40 wt. % of the at least one alkali metal nitrite, and from 1 to 40 wt. % of the at least one organic nitrogen-containing scavenger.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite and at least one organic nitrogen-containing scavenger; wherein the aqueous solution comprises from 14 to 35.6 wt. % of the at least one alkali metal nitrite, and from 3.1 to 30 wt. % of the at least one organic nitrogen-containing scavenger.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite, at least one organic nitrogen-containing scavenger, and at least one inorganic base.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite, at least one organic nitrogen-containing scavenger, and at least one inorganic base; wherein the aqueous solution comprises from 1 to 40 wt. % of the at least one alkali metal nitrite, from 1 to 40 wt. % of the at least one organic nitrogen-containing scavenger, and from greater than 0 to 15 wt. % of the at least one inorganic base.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite, at least one organic nitrogen-containing scavenger, and at least one inorganic base; wherein the aqueous solution comprises from 15.4 to 35 wt. % of the at least one alkali metal nitrite, from 3.1 to 30 wt. % of the at least one organic nitrogen-containing scavenger, and from 0.5 to 14 wt. % of the at least one inorganic base.

Another embodiment of the method of the present invention is anyone of the methods described above, wherein the hydrocarbon medium is a gas.

Another embodiment of the method of the present invention is any one of the methods described above, wherein the hydrocarbon medium is a liquid.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite and at least one organic nitrogen-containing scavenger; wherein the hydrocarbon medium is a gas; and wherein the aqueous solution comprises from 14 to 35 wt. % of the at least one alkali metal nitrite, and from 4 to 30 wt. % of the at least one organic nitrogen-containing scavenger.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite, at least one organic nitrogen-containing scavenger, and at least one inorganic base; wherein the hydrocarbon medium is a gas; and wherein the aqueous solution comprises from 14 to 35 wt. % of the at least one alkali metal nitrite, from 4 to 30 wt. % of the at least one organic nitrogen-containing scavenger, and from 0.5 to 14 wt. % of the at least one inorganic base.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite, at least one organic nitrogen-containing scavenger, and at least one inorganic base; wherein the hydrocarbon medium is a gas; and wherein the aqueous solution comprises from 10 to 25 wt. % of the at least one alkali metal nitrite, from 5 to 25 wt. % of the at least one organic nitrogen-containing scavenger, and from 0 to 10 wt. %, or from 1 to 10 wt. %, of the at least one inorganic base.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite and at least one organic nitrogen-containing scavenger; wherein the hydrocarbon medium is a liquid; and wherein the aqueous solution comprises from 15.4 to 35.6 wt. % of the at least one alkali metal nitrite, and from 3.1 to 23.2 wt. % of the at least one organic nitrogen-containing scavenger.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite, at least one organic nitrogen-containing scavenger, and at least one inorganic base; wherein the hydrocarbon medium is a liquid; and wherein the aqueous solution comprises from 15.4 to 35.6 wt. % of the at least one alkali metal nitrite, from 3.1 to 23.2 wt. % of the at least one organic nitrogen-containing scavenger, and from 3.13 to 14 wt. % of the at least one inorganic base.

Another embodiment of the method of the present invention is any one of the methods described above, wherein the at least one alkali metal nitrite is sodium nitrite, potassium nitrite or a combination thereof.

Another embodiment of the method of the present invention is any one of the methods described above, wherein the at least one organic nitrogen-containing scavenger is monoethanolamine (MEA); MEA triazine; diethanolamine (DEA); N-methyldiethanolamine (MDEA); diisopropylamine; diglycolamine (DGA); triethanolamine (TEA); alkylene polyamine; an alkylene polyamine/formaldehyde reaction product; a reaction product of ethylene diamine with formaldehyde; a N-butylamine formaldehyde reaction product; monomethylamine (MMA); monoethylamine; dimethylamine; dipropylamine; trimethylamine; triethylamine; tripropylamine; monomethanolamine; dimethanolamine; trimethanolamine; monoisopropanolamine; dipropanolamine; tripropanolamine; N-methylethanolamine; dimethyl ethanol amine; methyl diethanolamine; dimethyl amino ethanol; diamine; morpholine; N-methylmorpholine; pyrrolidone; piperazine; N,N-dimethylpiperazine; piperidine; N-methylpiperidine; piperidone; alkylpyridine; aminomethylcyclopentylamine; 1-2 cyclohexanediamine; or a combination thereof. In certain embodiments, the at least one organic nitrogen-containing scavenger comprises one or more alcohol amines, and particularly di-alcohol amines and tri-alcohol amines, such as diethanolamine (DEA); N-methyldiethanolamine (MDEA); triethanolamine (TEA); dimethanolamine; trimethanolamine; dipropanolamine; tripropanolamine; and the like.

As used herein, the term “alcohol amine” refers chemical compounds that contain both hydroxyl (—OH) and amino (—NH₂, —NHR, and —NR₂) functional groups on an alkane backbone. The terms di-alcohol amines and tri-alcohol amines refer to alcohol amines having two- or three hydroxyl groups, respectively.

Another embodiment of the method of the present invention is any one of the methods described above in the preceding paragraphs that uses at least one inorganic base, wherein the at least one inorganic base is an alkali metal hydroxide.

Another embodiment of the method of the present invention is any one of the methods described above, wherein the contacting is done in the presence of a compound comprising a transition metal in a high oxidation state.

Another embodiment of the method of the present invention is anyone of the methods described above, wherein the hydrocarbon medium is petroleum, a gas, a water/oil emulsion, a mixture of a water/oil emulsion and gas, a residual fuel, a straight-run fraction and distillate of secondary processing, a low-molecular hydrocarbon, an aromatic solvent, or a mixture of gases.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution of at least one alkali metal nitrite, and an aqueous solution of at least one organic nitrogen-containing scavenger; wherein the at least one alkali metal nitrite is present in a relative amount of 1 mole of the alkali metal nitrite per 2-4 moles of the sulfur in the sulfur-containing compound, and the at least one organic nitrogen-containing scavenger is present in a relative amount of 1 mole of nitrogen in the organic nitrogen-containing scavenger per 2-20 moles of the sulfur in the sulfur-containing compound; and wherein the hydrocarbon medium is a liquid.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution of at least one alkali metal nitrite, an aqueous solution of at least one organic nitrogen-containing scavenger, and an aqueous solution of at least one inorganic base; wherein the at least one alkali metal nitrite is present in a relative amount of 1 mole of the alkali metal nitrite per 2-4 moles of the sulfur in the sulfur-containing compound, the at least one organic nitrogen-containing scavenger is present in a relative amount of 1 mole of nitrogen in the organic nitrogen-containing scavenger per 2-20 moles of the sulfur in the sulfur-containing compound, and the at least one inorganic base is present in a relative amount of 1 mole of the inorganic base per 2-20 moles of the sulfur in the sulfur-containing compound; and wherein the hydrocarbon medium is a liquid.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution of at least one alkali metal nitrite, and an aqueous solution of at least one organic nitrogen-containing scavenger; wherein the at least one alkali metal nitrite is present in a relative amount of 1 mole of the alkali metal nitrite per 2-4 moles of the sulfur in the sulfur-containing compound, and the at least one organic nitrogen-containing scavenger is present in a relative amount of 1 mole of nitrogen in the organic nitrogen-containing scavenger per 2-20 moles of the sulfur in the sulfur-containing compound; wherein the hydrocarbon medium is a liquid; and wherein a single aqueous solution comprises the aqueous solution of at least one alkali metal nitrite and the aqueous solution of at least one organic nitrogen-containing scavenger.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution of at least one alkali metal nitrite, an aqueous solution of at least one organic nitrogen-containing scavenger, and an aqueous solution of at least one inorganic base; wherein the at least one alkali metal nitrite is present in a relative amount of 1 mole of the alkali metal nitrite per 2-4 moles of the sulfur in the sulfur-containing compound, the at least one organic nitrogen-containing scavenger is present in a relative amount of 1 mole of nitrogen in the organic nitrogen-containing scavenger per 2-20 moles of the sulfur in the sulfur-containing compound, and the at least one inorganic base is present in a relative amount of 1 mole of the inorganic base per 2-20 moles of the sulfur in the sulfur-containing compound; wherein the hydrocarbon medium is a liquid; and wherein a single aqueous solution comprises the aqueous solution of at least one alkali metal nitrite, the aqueous solution of at least one organic nitrogen-containing scavenger, and the aqueous solution of at least one inorganic base.

One embodiment of the composition of the present invention is a scavenger composition comprising: an aqueous solution comprising at least one alkali metal nitrite, and at least one organic nitrogen-containing scavenger.

Another embodiment of the composition of the present invention is a scavenger composition comprising: an aqueous solution comprising from 1 to 40 wt. % of at least one alkali metal nitrite, and from 1 to 40 wt. % of at least one organic nitrogen-containing scavenger.

Another embodiment of the composition of the present invention is a scavenger composition comprising: an aqueous solution comprising from 14 to 35.6 wt. % of at least one alkali metal nitrite, and from 3.1 to 30 wt. % of at least one organic nitrogen-containing scavenger.

Another embodiment of the composition of the present invention is a scavenger composition comprising: an aqueous solution comprising at least one alkali metal nitrite, at least one organic nitrogen-containing scavenger, and at least one inorganic base.

Another embodiment of the composition of the present invention is a scavenger composition comprising: an aqueous solution comprising from 1 to 40 wt. % of at least one alkali metal nitrite, from 1 to 40 wt. % of at least one organic nitrogen-containing scavenger, and from greater than 0 to 15 wt. % of at least one inorganic base.

Another embodiment of the composition of the present invention is a scavenger composition comprising: an aqueous solution comprises from 10 to 25 wt. % of the at least one alkali metal nitrite, from 5 to 25 wt. % of the at least one organic nitrogen-containing scavenger, and from 0 to 10 wt. %, or from 1 to 10 wt. %, of the at least one inorganic base.

Another embodiment of the composition of the present invention is a scavenger composition comprising: an aqueous solution comprising from 14 to 35.6 wt. % of the at least one alkali metal nitrite, from 3.1 to 30 wt. % of the at least one organic nitrogen-containing scavenger, and from 0.5 to 14 wt. % of the at least one inorganic base.

### DESCRIPTION OF THE DRAWINGS

FIG. 1 shows the adsorption of H₂S for the scavenger composition of Example 34 with a breakthrough curve of H₂S in the presence and absence of CO₂.

FIG. 2 shows the H₂S breakthrough curve for the scavenger composition of using MEA triazine.

### DETAILED DESCRIPTION

The present invention is directed to a composition and method for scavenging hydrogen sulfide and/or mercaptans from fluids, particularly those containing hydrocarbons. The composition and method of the present invention help to eliminate the drawbacks of the prior art, and can be employed in actual industrial conditions, such as during a relatively short-time scavenging directly in the oil well or in route from the oil well to the desalination and degasification plant, and in temporary storage tanks at reduced environmental temperatures. As such, the raw material undergoing the scavenging is not contaminated with reaction products, which are characteristic of the use of certain triazines or certain amine-aldehyde based scavengers.

The method of scavenging hydrogen sulfide and/or mercaptans may comprise treating a hydrocarbon media with a scavenger composition containing: an aqueous solution of an alkali metal nitrite and an organic water-soluble nitrogen-containing scavenger; and optionally, an aqueous solution of an inorganic base. Preferably, the scavenger composition does not include a polysulfide. Suitable water soluble nitrogen-containing scavengers include, but are not necessarily limited to: triazines (e.g., hexahydrotriazines made by reacting formaldehyde with an alkanolamine such as monoethanolamine (MEA), and other triazines made using an alkylamine such as monomethylamine, and an alkoxyalkylamine such as 3-methoxypropylamine (MOPA)); monoethanolamine (MEA); diethanolamine (DEA); N-methyldiethanolamine (MDEA); dimethylethanolamine (DMEA); diisopropylamine; diglycolamine (DGA); triethanolamine (TEA); alkylene polyamine; alkylene polyamine/formaldehyde reaction products; reaction products of ethylene diamine with formaldehyde; N-butylamine formaldehyde reaction product; monomethylamine (MMA); piperazine; piperidine; monoethylamine; dimethylamine; dipropylamine; trimethylamine; triethylamine; tripropylamine; monomethanolamine; dimethanolamine; trimethanolamine; monoisopropanolamine; dipropanolamine; tripropanolamine; N-methylethanolamine; dimethyl ethanol amine; methyl diethanolamine; dimethyl amino ethanol; diamines; morpholines; N-methylmorpholine; pyrrolidones; N,N-dimethylpiperazine; N-methylpiperidine; piperidones; alkylpyridines; aminomethylcyclopentylamine; 1, 2cyclohexanediamine; and combinations thereof.

The at least one organic nitrogen-containing scavenger may one or more alcohol amines, and particularly di-alcohol amines and tri-alcohol amines, such as diethanolamine (DEA); N-methyldiethanolamine (MDEA); triethanolamine (TEA); dimethanolamine; trimethanolamine; dipropanolamine; tripropanolamine; and the like.

Preferably, the alkali metal nitrites are nitrites of sodium and/or potassium. Preferably, the inorganic base is a hydroxide of sodium and/or potassium.

In a further embodiment of the present invention, the method of scavenging hydrogen sulfide and/or mercaptans from the hydrocarbon media is done by the above-described composition additionally in the presence of a transition metal in a high oxidation state, such as, for example, cobalt, copper, iron, manganese or vanadium, or mixtures thereof. The transition metals are preferably chosen from the group including Co (+3), Cu (+2), Fe (+3), Mn (≥+3) or V (≥+3) and their combinations. The transition metals can be employed, for example, in the form of water-soluble salts or complexes.

When the fluid containing hydrogen sulfide and/or mercaptans is a hydrocarbon, the hydrocarbon raw material can be chosen, for example, from the group including crude petroleum, water/oil emulsions, residual fuels, straight-run and cracked distillates, low-molecular hydrocarbons, aromatic solvents, and gaseous hydrocarbon mixtures.

One embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite and at least one organic nitrogen-containing scavenger; wherein the aqueous solution comprises from 5 to 35 wt. % of the at least one alkali metal nitrite, and from 1 to 35 wt. % of the at least one organic nitrogen-containing scavenger. In further embodiments, the aqueous solution comprises from 16-35.6 wt. % of the at least one alkali metal nitrite and from 10.5-21 wt. % of the at least one organic nitrogen-containing scavenger, or from 14-30.7 wt. % of the at least one alkali metal nitrite and from 3.1-14 wt. % of the at least one organic nitrogen-containing scavenger.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite, at least one organic nitrogen-containing scavenger, and at least one inorganic base; wherein the aqueous solution comprises from 5 to 35 wt. % of the at least one alkali metal nitrite, from 1 to 35 wt. % of the at least one organic nitrogen-containing scavenger, and from greater than 0 to 15 wt. % of the at least one inorganic base. In further embodiments, the aqueous solution comprises from 10 to 25 wt. % of the at least one alkali metal nitrite, from 5 to 25 wt. % of the at least one organic nitrogen-containing scavenger, and from 0 to 10 wt. %, or from 1 to 10 wt. % of the at least one inorganic base. In further embodiments, the aqueous solution comprises from 14 to 20 wt. % of the at least one alkali metal nitrite, from 8 to 22 wt. % of the at least one organic nitrogen-containing scavenger, and, optionally, from 2 to 8 wt. % of the at least one inorganic base. In further embodiments, the aqueous solution comprises from 14-30.7 wt. % of the at least one alkali metal nitrite, from 3.1-14 wt. % of the at least one organic nitrogen-containing scavenger, and from 2-14 wt. % of the at least one inorganic base.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite and at least one organic nitrogen-containing scavenger; wherein the hydrocarbon medium is a gas; and wherein the aqueous solution comprises from 14 to 24.1 wt. % of the at least one alkali metal nitrite, and from 9 to 14 wt. % of the at least one organic nitrogen-containing scavenger.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite, at least one organic nitrogen-containing scavenger, and at least one inorganic base; wherein the hydrocarbon medium is a gas; and wherein the aqueous solution comprises from 14 to 24.1 wt. % of the at least one alkali metal nitrite, from 9 to 14 wt. % of the at least one organic nitrogen-containing scavenger, and from 2 to 14 wt. % of the at least one inorganic base.

In another embodiment of the method of the present invention, the method comprises: contacting the hydrocarbon medium with an aqueous solution comprising at least one alkali metal nitrite, at least one organic nitrogen-containing scavenger, and at least one inorganic base; wherein the hydrocarbon medium is a gas; and wherein the aqueous solution comprises from 10 to 25 wt. % of the at least one alkali metal nitrite, from 5 to 25 wt. % of the at least one organic nitrogen-containing scavenger, and from 1 to 10 wt. % of the at least one inorganic base. In further embodiments, the aqueous solution comprises from 14 to 20 wt. % of the at least one alkali metal nitrite, from 8 to 22 wt. % of the at least one organic nitrogen-containing scavenger, and from 2 to 8 wt. % of the at least one inorganic base.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite and at least one organic nitrogen-containing scavenger; wherein the hydrocarbon medium is a liquid; and wherein the aqueous solution comprises from 15.4 to 30.7 wt. % of the at least one alkali metal nitrite, and from 3.1 to 13.6 wt. % of the at least one organic nitrogen-containing scavenger.

Another embodiment of the method of the present invention is a method for scavenging a sulfur-containing compound contained in a hydrocarbon medium, wherein the sulfur-containing compound is hydrogen sulfide, a mercaptan or a combination thereof. The method comprises: contacting the hydrocarbon medium with an aqueous solution comprising at least one alkali metal nitrite, at least one organic nitrogen-containing scavenger, and at least one inorganic base; wherein the hydrocarbon medium is a liquid; and wherein the aqueous solution comprises from 15.4 to 30.7 wt. % of the at least one alkali metal nitrite, from 3.1 to 13.6 wt. % of the at least one organic nitrogen-containing scavenger, and from 3.13 to 14 wt. % of the at least one inorganic base.

One embodiment of the composition of the present invention is a scavenger composition comprising: an aqueous solution comprising from 5 to 35 wt. % of at least one alkali metal nitrite, and from 1 to 35 wt. % of at least one organic nitrogen-containing scavenger. In further embodiments, the aqueous solution comprises from 16-35.6 wt. % of the at least one alkali metal nitrite and from 10.5-21 wt. % of the at least one organic nitrogen-containing scavenger, or from 14-30.7 wt. % of the at least one alkali metal nitrite and from 3.1-14 wt. % of the at least one organic nitrogen-containing scavenger.

Another embodiment of the composition of the present invention is a scavenger composition comprising: an aqueous solution comprising from 5 to 35 wt. % of at least one alkali metal nitrite, from 1 to 35 wt. % of at least one organic nitrogen-containing scavenger, and from greater than 0 to 15 wt. % of at least one inorganic base. In further embodiments, the aqueous solution comprises from 14-30.7 wt. % of the at least one alkali metal nitrite, from 3.1-14 wt. % of the at least one organic nitrogen-containing scavenger, and from 2-14 wt. % of the at least one inorganic base.

The aqueous solution of the alkali metal nitrite is preferably used in an amount of 1 mole of alkali metal nitrite per 2 to 4 moles of mercaptan and/or hydrogen sulfide sulfur. The nitrogen-containing scavenger is preferably used in an amount of 1 mole of amine group nitrogen per 2 to 20 moles of mercaptan and/or hydrogen sulfide sulfur. When the inorganic base is a hydroxide of sodium and/or potassium, the sodium and/or potassium hydroxides are preferably used in an amount of 1 mole of hydroxide per 2 to 20 moles of mercaptan and/or hydrogen sulfide sulfur. The transition metal in a high oxidation state is preferably used in an amount of 1 mole of transition metal per 30 to 1000 moles of mercaptan and/or hydrogen sulfide sulfur, more preferably in an amount of 1 mole of transition metal per 100 to 800 moles of mercaptan and/or hydrogen sulfide sulfur, and even more preferably in an amount of 1 mole of transition metal per 150 to 600 moles of mercaptan and/or hydrogen sulfide sulfur.

In accordance with the method of the present invention as described above, the processing with the scavenger composition comprising (1) an organic nitrogen-containing scavenger, and (2) an alkali metal nitrite, as well as (3) an optional inorganic base, is much more effective than, and provides a synergistic effect over, comparable scavenging done only by any one of these three components individually. That is, the sum of the moles of each of the three components used in the mixture composition gives a much better and effective result, i.e., it neutralizes significantly more moles of sulfur of hydrogen sulfide and/or mercaptans than if the same number of total moles were used as in the mixture composition, but only for one of the three mentioned components. The number of moles of the alkali metal nitrite and inorganic base that is used is determined in the usual manner by determining the molar mass. A mole of a substance such as a nitrogen based scavenger may include a number of moles of nitrogen (i.e., polyamine and triazine), and accordingly the amount of nitrogen containing scavenger is expressed in terms of moles of nitrogen, which this scavenger contains. Thus, the comparison of the effectiveness and the evaluation of the synergistic effect from the use of the composition having two or three components as described above is done by converting to the number of moles of the reagents used. For example, if a fixed number of N moles of any one of the three components as described above is used to neutralize a given fixed number of moles of hydrogen sulfide and mercaptans, then the result will be significantly better and more effective if a mixture of the above-described components were used, the sum of whose moles is N.

Preferably, the method of the present invention is performed at a temperature of from −5° C. to +100° C., even more preferably at a temperature of from +5° C. to +75° C.

Each of the three components described above can be used with no limit on their usage in the makeup of the same composition of an aqueous solution or a suspension in an aqueous solution, which simplifies the scheme of usage and introduction of the reagents in the reaction mixture of the hydrocarbon containing hydrogen sulfide and/or mercaptans. It should also be noted that certain components, such as amines, alkali, and nitrites, can be prepared in the form of a certain solution and kept with no further limit on the length of storage. However, prolonged storage of solutions, such as MEA triazines in solutions of strong alkalis, may result in undesirable hydrolysis. Therefore, it is preferable to prepare such compositions in situ, whereas other variants of neutralizing compositions can be prepared long before their use, as would be understood by one of ordinary skill in the art.

The present invention is directed to a composition and method for scavenging of hydrogen sulfide and mercaptans. The composition and method may allow for a sharp reduction in the time of the neutralization reactions. The composition and method of the present invention can be used under conditions where the possible access of air is excluded, and also at lowered environmental temperatures. The method of the present invention avoids the overconsumption of reagents, which is a consequence of the limited processing time, and also results in a more economical treatment method due to the use of cheaper and plentiful reagents and the ease of preparing the composition of the present invention. Consequently, the composition and method of the present invention are economically advantageous even in cases of treating raw material with a relatively high content of hydrogen sulfide and mercaptans.

An important benefit of the composition and method of the present invention is that they may be employed for scavenging of hydrogen sulfide and mercaptans even at low temperatures close to zero degrees Celsius, which allows for use in cold climate conditions when the hydrocarbon raw material is present in storage tanks without the possibility of being heated up. Another benefit of the present invention is that it provides a scavenger composition having a high effectiveness, and which also helps to prevent contamination of the process equipment, the storage tanks and the petroleum fractionation columns with difficult-to-remove compounds. Another benefit of the present invention is the possibility of using such a scavenger composition in conditions which exclude the additional involvement of oxygen in the air to carry out the oxidation reactions, which in turn avoids the problem of entrainment of the vapors of the light fractions and the recycling (burning) of the spent air. An additional benefit of the present invention is that it provides a composition for scavenging hydrogen sulfide and mercaptans that is made from plentiful components which are mass-produced by industry.

Quite unexpectedly, the inventors of the present invention have also found that the use of an organic nitrogen-containing scavenger in combination with an aqueous or aqueous-alkaline solution of an oxidizer—i.e., an alkali metal nitrite—for the oxidation of hydrogen sulfide and/or mercaptans in a hydrocarbon medium with no access to oxygen in the air makes it possible to largely avoid the aforementioned drawbacks of the currently known processes. In particular, in accordance with some embodiments of the present invention, it is possible to carry out the scavenging method at a high speed, without the involvement of oxygen in the air, and with less consumption of reagents as compared to the known processes. Little or no solid precipitates are formed in accordance with these embodiments of the present invention, in particular, including elemental sulfur, which is characteristic of reactions oxidizing hydrogen sulfide by an alkali metal nitrite. While not wishing to be bound by any particular theory or mechanism, it is believed that the organic nitrogen-containing scavenger acts as a catalyst for the oxidation of hydrogen sulfide and mercaptans by the joint use of the aqueous or aqueous-alkaline solution of an oxidizer—i.e., the alkali metal nitrite—in the hydrocarbon medium with no access to oxygen in the air. However, the exact mechanism of these chemical reactions is not entirely known, and thus, the organic nitrogen-containing scavenger may not be acting as a “catalyst” as that term is commonly understood in the art. Therefore, the interpretation of this scavenging method is not to be limited to any particular chemical reaction mechanism.

Another beneficial aspect of some embodiments of the present invention is that the presence of transition metals in a high oxidation state, such as, for example, those from the series cobalt (Co (3+)), copper (Cu (2+)), iron (Fe (3+)), manganese (Mn (≥3+)), or vanadium (V (≥3+)), as well as mixtures of these, has a catalytic effect and speeds up the target method of neutralization of hydrogen sulfide and/or mercaptans. The phrase “in a high oxidation state” as used herein means that the metal is characterized by such an initial valency that it can be reduced without forming the metal as a chemical element. The inventors do not limit themselves to any particular theory or mechanism as to the hypothesis that these metals play the role of catalysts. Suitable metals in a high oxidation state manifesting the requisite effect, as indicated above, include Co (+3), Fe (+3), Cu (+2), Mn (≥3+), V (≥3+) and their combinations. These metals may be present in the form of water-soluble salts and complexes. Examples of such metal complexes that are suitable for use in the composition and method of the present invention include, but are not limited to, the disodium salt of dichlorodisulfo acid of cobaltphthalocyanine; IVKAZ-T and salts of cobalt phthalocyanines which are known as Merox catalysts from the UOP company (currently Honeywell UOP); or ARI catalysts from the Merichem company. Other examples of such transition metal compounds include their complexes with ethylene diamine tetraacetic acid (EDTA), which are used on an industrial scale, as well as complexes with amines and polyatomic alcohols, which are readily obtained in situ by techniques known and available to one of ordinary skill in the art. However, the scavenger composition and method of the present invention can also be used without the presence of such transition metals in a high oxidation state.

Also, it is worth noting that the use of an organic nitrogen-containing scavenger as a catalyst should not have a negative influence on the waste waters into which the spent solution is discharged when using the given composition in the scavenging method. However, the presence of compounds of the indicated transition metals might lead to further contamination of the sump waters, the waste waters of the petroleum treatment facility, and so on, with metal-containing compounds. Therefore, the aforementioned transition-metal compounds should only be used in such cases that allow these forms of contaminants (such as, for example, when such waters are used in a reservoir pressure maintenance system). The inventors do not hereby restrict the area of application of the described composition and method of the present invention by the above-indicated reservations on the undesirable contamination of waste waters with transition metal compounds, but merely point out the need to take ecological factors into account. In accordance with the composition and method of the present invention, the use of only an organic nitrogen-containing compound as the catalyst is sufficient to achieve declared goals of the present invention. However, in those cases where permitted, the use of the aforementioned transition metal compounds can be useful in optimizing and further expediting the method.

As described above, an organic nitrogen-containing scavenger is used in the composition of an aqueous solution containing a nitrite or a mixture of a nitrite and a hydroxide of alkaline metals. In addition, such an aqueous solution may contain compounds of transition metals in a high oxidation state, preferably from the series Co (+3), Fe (+3), Cu (+2), Mn (≥3+), and V (≥3+) being present in the form of suspensions or solutions of salts or complexes. The resulting scavenger-reagent in the form of an aqueous solution or a suspension in an aqueous solution can be added to the hydrocarbon medium destined for scavenging by standard techniques, such as spraying it in or simply pouring it in to the hydrocarbon medium. Then, the added scavenger-reagent can be distributed throughout the entire volume by standard techniques, such as by mixing, or a gaseous hydrocarbon medium can bubble through a volume of the scavenger-reagent in a contact apparatus, such as a bubble tower. The scavenging is done in this way until the loss of the neutralizing properties of the scavenger-reagent.

The scavenging method of the present invention can be carried out at normal atmospheric or elevated pressure (for example, 14.7-250 psi). Also, the scavenging method of the present invention can be carried out at temperatures in the range of −50° C. through 900° C., in the range of −50° C. through room temperature, in the range of room temperature through 900° C., and at room temperature. Preferably, the temperature is in the range of −20° C. through 100° C. The method can even be carried out at higher temperatures, although such temperatures are not characteristic in petroleum extraction and treatment, or for the scavenging of petroleum products downstream from heat exchangers of the installation. Keeping in mind that the temperature limits of the hydrocarbon raw material being processed in systems for treatment of crude petroleum or gas, or in feeding petroleum products from a plant downstream from a cooler, are usually in the range of 30° C. to 60° C., the scavenger composition of the present invention can be used at temperatures of raw material being processed in this range of 30° C. to 60° C. When being supplied to the well, the scavenger composition of the present invention can even be used at product extraction temperatures up to 90° C. or more. The scavenger composition of the present invention can also be used at lower temperatures, for example, down to −5° C., under conditions of storage of petroleum in reservoirs in cold climate conditions. The scavenger composition of the present invention can also be used at even lower temperatures, and the inventors do not restrict the present invention to a particular indicated temperature below which the method is not applicable. However, the treatment time increases at lower temperatures. To shorten the treatment time, it may be necessary to increase the expenditure of reagent. Thus, the applicability of the method will depend on the conditions of each particular case, and the inventors do not herein restrict the area of application of the composition of the present invention to a lower temperature limit of −5° C., but rather indicate that this is a low temperature as a reference point for the primary range of applications.

The components of the scavenger composition of the present invention are typically manufactured by industry as heavy tonnage products. The components used in the scavenging method of the present invention are typically chemical reagents which are mass produced by industry. The components can be used in a whole composition/solution which is added to the hydrocarbon medium as a whole, but they can also be used in a way such that they are added to the hydrocarbon medium separately.

Additional components may optionally be added to the scavenger composition of the present invention. For example, various organic substances, or solvating additives, which are used to improve the contact of polar and nonpolar phases, may be added. Such solvating additives are known in the art, and include lower aliphatic alcohols, dialkyl sulfoxides, alkyl amides, glycols, sulfolan, sulfoxide, and others (see, e.g., RU 2358004, RU 2224006, U.S. Pat. Nos. 3,409,543, 6,960,291). One may also add to the scavenger composition of the present invention an organic nitrogen-containing substance known in the prior art—promoters of oxidation of mercaptans and hydrogen sulfide (see U.S. Pat. No. 4,753,722).

In addition, any suitable surfactants and phase transfer catalysts known in the prior art may also be added, such as, for example, phenolates; cresolates or naphthenates of alkaline metals or amines; alkyl polyglucosides; sulfonol; quaternary ammonium bases; fatty acid amides; N-oxides of amines; polyesters based on glycerin (Laprols); oxyalkylating glycols (Proxanols) or oxyalkylated ethylene diamine (Proxamines); oxyethylated alkylphenols (Neonols) or their mixtures (see, e.g., EAPO 018297, U.S. Pat. Nos. 8,900,446, 6,960,291). These additives can be introduced for improving the scavenging of mercaptans and hydrogen sulfide, and for achieving other goals in parallel—for example, as corrosion inhibitors, as reagents for separation of water/oil emulsions, or to improve the reservoir yield. Thus, an economic benefit may be achieved by using a single reagent for various purposes.

As indicated above, there are additional components which may optionally be added to the scavenger composition of the present invention. Such additives are well known in the art, and they can be chosen for each specific scavenging task, without limiting the generality of the scavenging method and scavenger composition of the present invention. In the exemplary embodiments of the invention as described hereinafter, the use of such additives is merely as an illustration, and does not limit the generality of the scavenging method and scavenger composition of the present invention. For each particular embodiment of the scavenger composition of the present invention, the choice as to whether to add such additional components, and if so, which ones, will depend on the properties of the hydrocarbon raw material, the conditions of the specific problem, the economics, and so on, as would be understood by one of ordinary skill in the art.

Again, without wishing to be bound by any particular theory or mechanism, the inventors believe that the organic nitrogen-containing scavenger and additionally the compounds of transition metals from the series Co (+3), Fe (+3), Cu (+2), Mn (≥3+), and V (≥3+) in a high oxidation state in the scavenger composition of the present invention serve the role of catalysts in the oxidation process of mercaptans and hydrogen sulfide, wherein the alkali metal nitrite acts as an oxidizer. However, in the context of the present invention, the inventors do not limit themselves to the confines of any particular theory or mechanism.

In accordance with the scavenging method of the present invention, the scavenger composition of the present invention selectively interacts with hydrogen sulfide and mercaptans, while the products of the reaction do not contain by-products with a foul, unpleasant odor, which favorably distinguishes the scavenging method of the present invention from scavenging via the chemicals that are widely used in the industry today, which are based on amine-aldehyde derivatives and triazines. Thus, the scavenger composition of the present invention enables the removal of volatile mercaptans and hydrogen sulfide whose presence in the material is the primary cause of the unpleasant odor and corrosion.

An additional advantage of the scavenging method of the present invention is an improvement in the copper strip corrosion test indicators of oil distillates after treatment by such embodiments. It has been shown that the presence of the organic nitrogen-containing scavenger and in addition the above-indicated transition metals result in a substantial increase in the rate of scavenging of hydrogen sulfide and low-molecular weight mercaptans from the material, and also enables a scavenging at low temperatures. These factors are important for the use of the scavenging method of the present invention in actual industrial conditions.

As discussed above, the option of using the transition metal compounds discussed herein can be employed in such instances where the use of such transition metals is possible and permissible. In some cases, such a possibility may be absent. For example, such is the case when the scavenging needs to be done in tanks at port terminals, and the waste waters are directed by the storm drains to the general sewage collector. In that case, further contamination of the effluents with heavy metal compounds is not allowed. Therefore, in such cases, only the organic nitrogen-containing scavenger would be used in the scavenger composition of the present invention.

### EXAMPLES

The following examples are presented to illustrate certain exemplary embodiments of the present invention, and the present invention is not limited to these examples. As such, the following examples do not exhaust all possible variations of the embodiments of the present invention, as the present invention is herein described.

The examples presented herein employ the scavenger composition of the present invention in the form of aqueous solutions of the indicated substances at the level of solubility at room temperature under ordinary conditions. The solutions were obtained by simply dissolving the components in water. All experiments were conducted in an argon atmosphere. The flask in which the treatment of the hydrocarbon raw material with the scavenger composition took place was purged with argon prior to and after filling the flask with the hydrocarbon raw material.

In examples 1-18, the hydrocarbon raw material for the scavenging was petroleum with a hydrogen sulfide content of 254 ppm (methyl and ethyl mercaptans absent). The content of residual water was 0.2 wt. %.

In examples 19-24, the hydrocarbon raw material for the scavenging was crude watered petroleum with a hydrogen sulfide content of 39 ppm, and total methyl-ethyl mercaptans (RSH) content of 398 ppm. The water content was 6.1 wt. %.

In examples 1-24, the measurements of hydrogen sulfide, and methyl and ethyl mercaptans were done by the chromatography method per Russian standard GOST 33690-2015.

The results for examples 1-27 are presented in Table 1 below, and the table columns contain the following information:
Column C1: number of moles of sulfur of hydrogen sulfide/mercaptans per mole of alkali metal nitrite; wt. % content of the particular nitrite in the scavenger composition
Column C2: number of moles of sulfur of hydrogen sulfide/mercaptans per mole of nitrogen of the organic nitrogen-containing scavenger; wt. % content of the organic nitrogen-containing scavenger in the scavenger composition
Column C3: number of moles of sulfur of hydrogen sulfide/mercaptans per mole of transition metal compound; wt. % content of the transition metal compound of variable valency in the scavenger composition
Column C4: number of moles of sulfur of hydrogen sulfide/mercaptans per mole of alkali metal hydroxide; wt. % content of the alkali metal hydroxide compound in the scavenger composition
Column C5: dosage of scavenger composition, in grams (g) per metric ton (T) of hydrocarbon raw material being treated
Column C6: conditions of treatment, wherein t is the temperature of the material, and [symbol] is the treatment time.

In example 27, the hydrocarbon raw material for the scavenging was visbreaker naphtha—fraction IBP −180° C., distillate of visbreaking process of tar products, corresponding to the Russian standard TU 0251-001-47073029-2003. The content of hydrogen sulfide was 10 ppm, and the content of methyl-ethyl mercaptans was 1250 ppm. The total sulfur content was 1.49%. The fraction did not pass the copper strip corrosion test (class 3B). This fraction is usually characterized by a high content of total sulfur (usually up to 2%) and a high content of olefins—iodine number is usually up to 50 g iodine per 100 g of product. The fraction is unstable and after treatment by the method of sweetening with the use of oxygen, gel-like agglomerates form. The agglomerates are polycondensation products of oxiranes (epoxides), which are formed as a result of oxidation of unsaturated hydrocarbons by the oxygen of air in the presence of sweetening catalysts. Scavenging with the method of the present invention did not produce such unwanted agglomeration by-products, and the fraction after the treatment passed the copper strip corrosion test (class 1A).

In examples 28-29, the hydrocarbon raw material for the scavenging was associated petroleum gas (APG). The requirements for scavenging of hydrogen sulfide and mercaptans are according to the Russian standard STO Gazprom 089-2010 for transportation in pipelines (hydrogen sulfide up to 0.007 g/m³, mercaptans up to 0.016 g/m³). Analysis of the gas for content of hydrogen sulfide and mercaptans was done by the chromatography method per Russian standard GOST R 53367-2009.

In example 30, the hydrocarbon raw material for the scavenging was heating oil, a mixture of the heavy fraction of catalytic cracking gas oil (75%) and the diesel fraction (25%), with a hydrogen sulfide content of 27 ppm. The use of the scavenger composition was in accordance with the procedure of Examples 1-14. The dosage of the scavenger composition was 130 g/T. The measurements of the hydrogen sulfide content were taken in two hours per Russian standard GOST R 53716-2009 (IP 399/94).

### Example 1

In this example, as in all the other examples referencing this example, when preparing the scavenger composition, the reagents were added to the solution in succession: first the dry ones, and then after they dissolved, then the liquid ones. The mixing was performed until a uniform product was obtained, and all of the preparations were done at room temperature.

In a flask, 65.95 g of distilled water was added, followed by 24.3 g of sodium nitrite. After dissolving the sodium nitrite, 5.3 g of sodium hydroxide was added. After dissolving the sodium hydroxide, 4.45 g of diethanolamine (DEA) was added, and mixing was done to obtain a uniform product. A scavenger composition was obtained having: sodium nitrite (24.3 wt. %), sodium hydroxide (5.3 wt. %), diethanolamine (4.45 wt. %), and the remainder (65.95 wt. %) being water. This scavenger composition was used for the neutralization of 254 ppm of hydrogen sulfide in the petroleum.

96 g of crude petroleum was placed in a thermostatically controlled flask with a jacket, provided with a magnetic stirrer. Then, a calculated amount of the scavenger composition was placed in the flask, starting with a dosage of 750 g/T, i.e., 0.072 g. The flask was blown out with argon to remove the air. The reaction mixture was mixed for the specified time at the specified temperature. The measurement of the hydrogen sulfide content in this example was taken at 90 min (result was 45 ppm) and at 150 min (result was less than 0.5 ppm). The temperature of the petroleum in this example was +35° C.

Table 1 below indicates the doses of the scavenger composition, the wt. % content of each component making up the scavenger composition, and the ratio of each component to the hydrogen sulfide (and mercaptans), expressed in the number of moles of sulfur of hydrogen sulfide (and mercaptans) per 1 mole of the given component. For the organic nitrogen-containing scavenger, the molar ratio to hydrogen sulfide is expressed in the number of moles of hydrogen sulfide per mole of nitrogen, i.e., the circumstance is taken into account that the molecule of the nitrogen-containing scavenger may contain several atoms of nitrogen. In this Example 1, for one mole of hydrogen sulfide (H₂S), there is needed in the scavenger composition: 0.3333 moles of NaNO₂, 0.04 moles of nitrogen in DEA, and 0.125 moles of NaOH. In total, for one mole of hydrogen sulfide, about 0.5 moles of the indicated components altogether are required.

### Example 2

The preparation of the solution of the scavenger composition was done in a way similar to that described above in Example 1. The stoichiometric amount of the components in the scavenger composition was the same as in Example 1, with the exception that the water content was 68.03 wt. %, and instead of diethanolamine, monoethanolamine (MEA) triazine was used, and its content in the solution of the scavenger composition was 3.1 wt. %. It should be noted that since the molecule monoethanolamine (MEA) triazine, C₉H₂₁N₃O₃, contains three atoms of nitrogen, the ratio of 25 moles of hydrogen sulfide to 1 mole of nitrogen is the same as in Example 1.

In a flask, 65.63 g of distilled water was added, followed by 24.3 g of sodium nitrite. After dissolving the sodium nitrite, 5.3 g of sodium hydroxide was added. After dissolving the sodium hydroxide, 4.77 g of a 65% aqueous solution of monoethanolamine (MEA) triazine was added, and mixing was done to obtain a uniform product. A scavenger composition was obtained having: sodium nitrite (24.3 wt. %), sodium hydroxide (5.3 wt. %), monoethanolamine (MEA) triazine (3.1 wt. %), and the remainder (67.3 wt. %) being water. This scavenger composition was used for the neutralization of 254 ppm of hydrogen sulfide in the petroleum.

The testing of the scavenger composition was done in a way similar to that of Example 1: 96 g of crude petroleum was placed in a thermostatically controlled flask with a jacket, provided with a magnetic stirrer. Then, a calculated amount of the scavenger composition was placed in the flask, starting with a dosage of 750 g/T, i.e., 0.072 g. The flask was purged with argon to remove the air. The reaction mixture was mixed for the specified time at the specified temperature. The measurement of the hydrogen sulfide content in this example was taken at 90 min (result was 37 ppm) and at 150 min (result was less than 0.5 ppm). The temperature of the petroleum in this example was +35° C.

In this Example 2, for one mole of hydrogen sulfide (H₂S), there is needed in the scavenger composition: 0.3333 moles of NaNO₂, 0.04 moles of nitrogen in triazine, and 0.125 moles of NaOH. In total, for one mole of hydrogen sulfide, about 0.5 moles of the indicated components altogether are required.

### Example 3

The preparation of the solution of the scavenger composition was done in a way similar to that described above in Example 1. In a flask, 63.5 g of distilled water was added, followed by 36.5 g of sodium nitrite, and mixing was done to complete dissolving. A scavenger composition was obtained having only sodium nitrite (36.5 wt. %) and water (63.5 wt. %). The obtained solution was used for the neutralization of 254 ppm of hydrogen sulfide in the petroleum.

The testing of the scavenger composition was done in a way similar to that of Example 1: 96 g of crude petroleum was placed in a thermostatically controlled flask with a jacket, provided with a magnetic stirrer. Then, a calculated amount of the scavenger composition was placed in the flask, starting with a dosage of 750 g/T, i.e., 0.072 g. The flask was purged with argon to remove the air. The reaction mixture was mixed for the specified time at the specified temperature. The measurement of the hydrogen sulfide content in this example was taken at 90 min (result was 191 ppm) and at 150 min (result was 162 ppm). The temperature of the petroleum in this example was +35° C.

In this Example 3, for one mole of hydrogen sulfide (H₂S), 0.5 moles of sodium nitrite (NaNO₂) were used in the scavenger composition. Thus, just as in Examples 1 and 2, one mole of hydrogen sulfide requires 0.5 moles of the indicated components.

### Example 4

The preparation of the solution of the scavenger composition was done in a way similar to that described above in Example 1. In a flask, 40.57 g of distilled water was added, followed by 59.43 g of monoethanolamine (MEA) triazine in the form of a 65% aqueous solution, and mixing was done to complete dissolving. A scavenger composition was obtained having only monoethanolamine (MEA) triazine (38.63 wt. %) and water (61.37 wt. %). The obtained solution was used for the neutralization of 254 ppm of hydrogen sulfide in the petroleum.

The testing of the scavenger composition was done in away similar to that of Example 1: 96 g of crude petroleum was placed in a thermostatically controlled flask with a jacket, provided with a magnetic stirrer. Then, a calculated amount of the scavenger composition was placed in the flask, starting with a dosage of 750 g/T, i.e., 0.072 g. The flask was purged with argon to remove the air. The reaction mixture was mixed for the specified time at the specified temperature. The measurement of the hydrogen sulfide content in this example was taken at 90 min (result was 211 ppm) and at 150 min (result was 197 ppm). The temperature of the petroleum in this example was +35° C.

In this Example 4, for one mole of hydrogen sulfide (H₂S), 0.5 moles of nitrogen in MEA triazine were used in the scavenger composition. Thus, just as in Examples 1 and 2, one mole of hydrogen sulfide requires 0.5 moles of the indicated components.

### Example 5

The preparation of the solution of the scavenger composition was done in a way similar to that described above in Example 1. In a flask, 78.8 g of distilled water was added, followed by 21.2 g of sodium hydroxide (NaOH), and mixing was done to complete dissolving. A scavenger composition was obtained having only sodium hydroxide (21.2 wt. %) and water (78.8 wt. %). The obtained solution was used for the neutralization of 254 ppm of hydrogen sulfide in the petroleum.

The testing of the scavenger composition was done in away similar to that of Example 1: 96 g of crude petroleum was placed in a thermostatically controlled flask with a jacket, provided with a magnetic stirrer. Then, a calculated amount of the scavenger composition was placed in the flask, starting with a dosage of 750 g/T, i.e., 0.072 g. The flask was purged with argon to remove the air. The reaction mixture was mixed for the specified time at the specified temperature. The measurement of the hydrogen sulfide content in this example was taken at 90 min (result was 195 ppm) and at 150 min (result was 192 ppm). The temperature of the petroleum in this example was +35° C.

In this Example 5, for one mole of hydrogen sulfide (H₂S), 0.5 moles of sodium hydroxide were used in the scavenger composition. Thus, just as in Examples 1 and 2, one mole of hydrogen sulfide requires 0.5 moles of the indicated components.

### Example 6

The preparation of the solution of the scavenger composition was done in a way similar to that described above in Example 1. In a flask, 44.36 g of distilled water was added, followed by 55.64 g of diethanolamine (DEA), and mixing was done to complete dissolving. A scavenger composition was obtained having only DEA (55.64 wt. %) and water (44.36 wt. %). The obtained solution was used for the neutralization of 254 ppm of hydrogen sulfide in the petroleum.

The testing of the scavenger composition was done in away similar to that of Example 1: 96 g of crude petroleum was placed in a thermostatically controlled flask with a jacket, provided with a magnetic stirrer. Then, a calculated amount of the scavenger composition was placed in the flask, starting with a dosage of 750 g/T, i.e., 0.072 g. The flask was purged with argon to remove the air. The reaction mixture was mixed for the specified time at the specified temperature. The measurement of the hydrogen sulfide content in this example was taken at 90 min (result was 173 ppm) and at 150 min (result was 142 ppm). The temperature of the petroleum in this example was +35° C.

In this Example 6, for one mole of hydrogen sulfide (H₂S), 0.5 moles of nitrogen in DEA were used in the scavenger composition. Thus, just as in Examples 1 and 2, one mole of hydrogen sulfide requires 0.5 moles of the indicated components.

The results of Examples 3, 4, 5 and 6 as compared to those of Examples 1 and 2 show that the separate use of each neutralizing agent alone—i.e., sodium nitrite, nitrogen-containing scavenger, and sodium hydroxide in a quantity of 0.5 moles per mole of hydrogen sulfide—produces a significantly worse result than the synergistic effect resulting from the combined use of all neutralizing reagents in the same quantity and ratio—at 0.5 total moles per mole of hydrogen sulfide.

### Example 7

The preparation of the solution of the scavenger composition was done in a way similar to that described above in Example 1. In a flask, 64.95 g of distilled water was added, followed by 24.3 g of sodium nitrite. After dissolving the sodium nitrite, 5.3 g of sodium hydroxide was added. After dissolving the sodium hydroxide, 1.0 g of the catalyst Merox (from Honeywell UOP) was added. After dissolving the Merox catalyst, 4.45 g of diethanolamine (DEA) was added, and mixing was done to obtain a uniform product. A scavenger composition was obtained having: Merox catalyst (1.0 wt. %), sodium nitrite (24.3 wt. %), sodium hydroxide (5.3 wt. %), DEA (4.45 wt. %), and the remainder being water. This scavenger composition was used for the neutralization of 254 ppm of hydrogen sulfide in the petroleum.

The testing of the scavenger composition was done in away similar to that of Example 1: 96 g of crude petroleum was placed in a thermostatically controlled flask with a jacket, provided with a magnetic stirrer. Then, a calculated amount of the scavenger composition was placed in the flask, starting with a dosage of 750 g/T, i.e., 0.072 g. The flask was purged with argon to remove the air. The reaction mixture was mixed for the specified time at the specified temperature. The measurement of the hydrogen sulfide content in this example was taken at 90 min (result was 12 ppm) and at 120 min (result was less than 0.5 ppm). The temperature of the petroleum in this example was +35° C.

The results of Example 7 as compared to those of Example 1 show that the presence of a transition metal in a high oxidation state (in the present case, Co (+3) in the form of an organic complex) leads to an improved result.

### Example 8

The preparation of the solution of the scavenger composition was done in a way similar to that described above in Example 7. In a flask, 65.2 g of distilled water was added, followed by 24.3 g of sodium nitrite. After dissolving the sodium nitrite, 5.3 g of sodium hydroxide was added. After dissolving the sodium hydroxide, 0.75 g of the catalyst Merox (from Honeywell UOP) was added. After dissolving the Merox catalyst, 4.45 g of diethanolamine (DEA) was added, and mixing was done to obtain a uniform product. A scavenger composition was obtained having: Merox catalyst (0.75 wt. %), sodium nitrite (24.3 wt. %), sodium hydroxide (5.3 wt. %), DEA (4.45 wt. %), and the remainder being water. This scavenger composition was used for the neutralization of 254 ppm of hydrogen sulfide in the petroleum.

The testing of the scavenger composition was done in away similar to that of Example 1: 96 g of crude petroleum was placed in a thermostatically controlled flask with a jacket, provided with a magnetic stirrer. Then, a calculated amount of the scavenger composition was placed in the flask, starting with a dosage of 750 g/T, i.e., 0.072 g. The flask was purged with argon to remove the air. The reaction mixture was mixed for the specified time at the specified temperature. The measurement of the hydrogen sulfide content in this example was taken at 90 min (result was 44 ppm) and at 150 min (result was less than 0.5 ppm). The temperature of the petroleum in this example was +35° C.

The results of Example 8 as compared to those of Examples 1 and 7 show that reducing the fraction of the transition metal outside of the preferred limits leads to a result practically the same as the result for a total absence of the transition metal.

### Example 9

The preparation of the solution of the scavenger composition was done in a way similar to that described above in Example 1. A scavenger composition was obtained having: sodium nitrite (35.6 wt. %), monoethanolamine (MEA) (10.5 wt. %) and the remainder being water. This scavenger composition was used for the neutralization of 254 ppm of hydrogen sulfide in the petroleum.

The testing of the scavenger composition was done in away similar to that of Example 1: 96 g of crude petroleum was placed in a thermostatically controlled flask with a jacket, provided with a magnetic stirrer. Then, a calculated amount of the scavenger composition was placed in the flask, starting with a dosage of 770 g/T, i.e., 0.074 g. The flask was purged with argon to remove the air. The reaction mixture was mixed for the specified time at the specified temperature. The measurement of the hydrogen sulfide content in this example was taken at 90 min (result was 34 ppm) and at 150 min (result was 3 ppm). The temperature of the petroleum in this example was +40° C.

### Example 10

The preparation of the solution of the scavenger composition was done in a way similar to that described above in Example 1. A scavenger composition was obtained having: sodium nitrite (39.0 wt. %), monoethanolamine (MEA) (5.25 wt. %), and the remainder being water. This scavenger composition was used for the neutralization of 254 ppm of hydrogen sulfide in the petroleum.

The testing of the scavenger composition was done in away similar to that of Example 1: 96 g of crude petroleum was placed in a thermostatically controlled flask with a jacket, provided with a magnetic stirrer. Then, a calculated amount of the scavenger composition was placed in the flask, starting with a dosage of 1402 g/T. The flask was purged with argon to remove the air. The reaction mixture was mixed for the specified time at the specified temperature. The measurement of the hydrogen sulfide content in this example was taken at 90 min (result was 31 ppm) and at 150 min (result was less than 2.5 ppm). The temperature of the petroleum in this example was +40° C.

The results of Example 10 as compared to those of Example 9 show that increasing the fraction of the alkali metal nitrite above the preferred molar limits does not result in a noticeable improvement of the result. In Example 10, the dosage was increased by additional water in view of the need to dissolve the components, but this did not affect the ratio of reagents and hydrogen sulfide.

### Example 11

The preparation of the solution of the scavenger composition was done in a way similar to that described above in Example 1, except that the organic nitrogen-containing scavenger component was prepared and added separately from the sodium nitrite component, as described below. The mixing in this example was done until a uniform product was obtained, and all of the preparations were done at room temperature.

In a flask, 64.5 g of distilled water was added, followed by 35.5 g of sodium nitrite, and mixing was done to complete dissolving. This is “Solution A.”

A mixture of organic nitrogen-containing scavengers was prepared separately from Solution A. In a laboratory beaker, 2.25 g of distilled water was added, and then 2.73 g of monoethanolamine (MEA) was added, and then 5.02 g of a 65% solution of MEA triazine was added. The obtained mixture comprising 27.3% monoethanolamine and 32.6% MEA triazine was mixed until a uniform product was formed—this is “Solution B.” The obtained solution of sodium nitrite (Solution A) and the mixture of organic nitrogen-containing scavengers (Solution B) were used for the neutralization of 254 ppm of hydrogen sulfide in the petroleum.

The testing of the scavenger composition was done in away similar to that of Example 1, except that two scavenging solutions, and not one, were added to the flask with petroleum. 96 g of crude petroleum was placed in a thermostatically controlled flask with a jacket, provided with a magnetic stirrer. Then, a calculated amount of Solution A was placed in the flask, starting with a dosage of 770 g/T, i.e., 0.074 g. Next, a calculated amount of Solution B was placed in the flask, starting with a dosage of 148 g/T, i.e., 0.0142 g. The flask was purged with argon to remove the air. The reaction mixture was mixed for the specified time at the specified temperature. The measurement of the hydrogen sulfide content in this example was taken at 90 min (result was 28 ppm) and at 150 min (result was less than 1.5 ppm). The temperature of the petroleum in this example was +40° C.

In this Example 11, the consumption of chemical reagents per one mole of hydrogen sulfide (H₂S) was the same as in Example 9: 2 moles of H₂S per 1 mole of sodium nitrite, 6 moles of H₂S per 1 mole of nitrogen (12 moles of H₂S per 1 mole of monoethanolamine and 12 moles of H₂S per 1 mole of nitrogen in triazine).

The results of Example 11 demonstrate the possibility of separately adding to the hydrocarbon media an aqueous solution of alkali metal nitrite and an aqueous solution of nitrogen-containing scavenger, i.e., not mixing them together prior to each contacting the hydrocarbon media.

### Example 12

The preparation of the solution of the scavenger composition was done in a way similar to that described above in Examples 1, 2 and 7-11. A scavenger composition was obtained having: sodium nitrite (20.8 wt. %), polyethylene polyamine (PEPA) (13.6 wt. %), CuEDTA (complex of copper II and EDTA) (1.1 wt. %), potassium hydroxide (4.6 wt. %), and the remainder being water. This scavenger composition was used for the neutralization of 254 ppm of hydrogen sulfide in the petroleum.

The testing of the scavenger composition was done in away similar to that of Examples 1-11, with the exception of the mixing. The mixing was done for the first ten minutes, after which there was practically no continuous mixing. The dosage of the scavenger composition was 640 g/T. The measurement of the hydrogen sulfide content in this example was taken at 22 hours (result was 59 ppm) and at 36 hours (result was less than 0.5 ppm). The temperature of the petroleum in this example was −5° C.

The results of Example 12 demonstrate the possibility of employing the scavenging method of the present invention at lowered temperatures. It simulates a situation of treatment in temporary storage tanks.

### Example 13

The preparation of the solution of the scavenger composition was done in a way similar to that described above in Examples 1, 2 and 7-12. A scavenger composition was obtained having: potassium nitrite (KNO₂) (24.1 wt. %), FeEDTA (complex of iron III and EDTA) (1.2 wt. %), aminoethyl piperazine (7.0 wt. % (based on a calculation of 7 moles of sulfur per 1 mole of amine group; aminoethyl piperazine contains one primary, one secondary and one tertiary amine group)), sodium hydroxide (4.5 wt. %), and the remainder being water. This scavenger composition was used for the neutralization of 254 ppm of hydrogen sulfide in the petroleum.

The testing of the scavenger composition was done in away similar to that of Examples 1-11. The dosage of the scavenger composition was 700 g/T. The measurement of the hydrogen sulfide content in this example was taken at 150 min (result was 31 ppm) and at 240 min (result was 2.5 ppm). The temperature of the petroleum in this example was +35° C.

### Example 14

The preparation of the solution of the scavenger composition was done in a way similar to that described above in Examples 1, 2 and 7-13. A scavenger composition was obtained having: potassium nitrite (KNO₂) (24.1 wt. %), FeEDTA (complex of iron III and EDTA) (1.2 wt. %), aminoethyl piperazine (1.0 wt. % (based on a calculation of 49 moles of sulfur per 1 mole of amine group)), sodium hydroxide (4.5 wt. %) and the remainder being water. This scavenger composition was used for the neutralization of 254 ppm of hydrogen sulfide in the petroleum.

The testing of the scavenger composition was done in away similar to that of Examples 1-11. The dosage of the scavenger composition was 700 g/T. The measurement of the hydrogen sulfide content in this example was taken at 240 min (result was 124 ppm). The temperature of the petroleum in this example was +35° C.

The results of Example 14 as compared to those of Example 13 show that decreasing the fraction of the nitrogen-containing scavenger below the preferred molar limits results in a noticeable worsening of the result.

### Example 15

The preparation of the solution of the scavenger composition was done in a way similar to that described above in Examples 1, 2 and 7-14. A scavenger composition was obtained having: sodium nitrite (27.4 wt. %), MnEDTA (complex of manganese II and EDTA) (0.7 wt. %), aminoethyl ethanolamine (5.9 wt. % (considering that two amino groups, a primary one and a secondary one, are present in this compound), sodium hydroxide (3.2 wt. %), and the remainder being water. This scavenger composition was used for the neutralization of 254 ppm of hydrogen sulfide in the petroleum.

The testing of the scavenger composition was done in away similar to that of Examples 1-11. The dosage of the scavenger composition was 500 g/T. The measurement of the hydrogen sulfide content in this example was taken at 150 min (result was 47 ppm) and at 240 min (result was 12 ppm). The temperature of the petroleum in this example was +35° C.

### Example 16

The preparation of the solution of the scavenger composition was done in a way similar to that described above in Examples 1, 2 and 7-15. A scavenger composition was obtained having: potassium nitrite (25.0 wt. %), Merox catalyst (0.67 wt. %) ethylene diamine (3.6 wt. % (counting two amino groups in this compound, i.e., two moles of nitrogen), sodium hydroxide (3.13 wt. %), and the remainder being water. This scavenger composition was used for the neutralization of 254 ppm of hydrogen sulfide in the petroleum.

The testing of the scavenger composition was done in away similar to that of Examples 1-10. The dosage of the scavenger composition was 670 g/T. The measurement of the hydrogen sulfide content in this example was taken at 240 min (result was 38 ppm) and at 300 min (result was 6 ppm). The temperature of the petroleum in this example was +23° C.

### Example 17

The preparation of the solution of the scavenger composition was done in a way similar to that described above in Examples 1, 2 and 7-16. However, this example also contained a surfactant, which was a mixture of alkyl polyglucosides and oxyethylated fatty alcohols (brand name TRITON SG-50), which was added after the dry components were added and after the ethylene diamine was added to the solution. A scavenger composition was obtained having: potassium nitrite (25.0 wt. %), Merox catalyst (0.67 wt. %), ethylene diamine (3.6 wt. % (considering that this compound has two amino groups, both primary ones)), sodium hydroxide (3.13 wt. %), TRITON SG-50 (0.7 wt. %), and the remainder being water. This scavenger composition was used for the neutralization of 254 ppm of hydrogen sulfide in the petroleum.

The testing of the scavenger composition was done in away similar to that of Examples 1-10. The dosage of the scavenger composition was 670 g/T. The measurement of the hydrogen sulfide content in this example was taken at 240 min (result was 3 ppm). The temperature of the petroleum in this example was +23° C.

The results of Example 17 as compared to those of Example 16 show that the use of a surfactant can improve the result.

### Example 18

The preparation of the solution of the scavenger composition was done in a way similar to that described above in Examples 1, 2 and 7-17. A scavenger composition was obtained having: potassium nitrite (25.0 wt. %), piperazine (12.8 wt. % (considering that this compound has two secondary amino groups)), sodium hydroxide (3.13 wt. %), and the remainder being water. This scavenger composition was used for the neutralization of 254 ppm of hydrogen sulfide in the petroleum.

The testing of the scavenger composition was done in away similar to that of Examples 1-12, with the following exceptions. The testing was done on three different samples of the identical petroleum in three different instances, differing from each other by the temperature of the environment in which the treatment was done (with temperatures of +55° C., +5° C., −5° C.), and also by the conditions of mixing and the length of the treatment. For conditions with a low temperature and no mixing, the treatment (contact) time was increased. The mixing of the sample being treated at +55° C. was done in the usual manner (as in Example 1), but for the other two samples there was practically no continual mixing. The dosage of the scavenger composition was the same in each sample, 670 g/T. At the treatment temperature of +55° C., the measurement of the hydrogen sulfide content was taken after 120 min and was 2 ppm. At the treatment temperature of +5° C., the measurement of the hydrogen sulfide content was taken after 20 hours and was 2 ppm. At the treatment temperature of −5° C., the measurement of the hydrogen sulfide content was taken after 32 hours and was 4 ppm.

Example 18 demonstrates the influence of the temperature and the mixing conditions on the length of the hydrogen sulfide scavenging method of the present invention and its result.

### Example 19

In this and the following examples through Example 26, the raw material for the treatment was watered crude petroleum with a content of hydrogen sulfide of 39 ppm, and a content of methyl and ethyl mercaptans (RSH) of 398 ppm (combined for methyl and ethyl mercaptans). The water content was 6.1%.

The preparation of the solution of the scavenger composition was done in a way similar to that described above in Examples 1, 2 and 7-18. A scavenger composition was obtained having: sodium nitrite (15.4 wt. %), piperidine (3.9 wt. %), FeEDTA (complex of iron III and EDTA) (1.13 wt. %), sodium hydroxide (7.3 wt. %), and the remainder being water. This scavenger composition was used for the neutralization of hydrogen sulfide and mercaptans in the given petroleum sample.

The testing of the scavenger composition was done in away similar to that of Examples 1-12. The dosage of the scavenger composition was 1500 g/T. The measurements of the hydrogen sulfide content and the methyl and ethyl mercaptans content (RSH) in this example were taken at 6 hours (result: H₂S, less than 0.5 ppm; RSH, 24 ppm). The temperature of the petroleum in this example was +42° C.

### Example 20

The preparation of the solution of the scavenger composition was done in a way similar to that described above in Examples 1, 2 and 7-19. A scavenger composition was obtained having: sodium nitrite (30.7 wt. %), piperidine (3.9 wt. %), Merox catalyst (0.8 wt. %), sodium hydroxide (7.34 wt. %), and the remainder being water. This scavenger composition was used for the neutralization of hydrogen sulfide and mercaptans in the petroleum sample with a content of hydrogen sulfide of 39 ppm, and a content of methyl and ethyl mercaptans (RSH) of 398 ppm (combined for methyl and ethyl mercaptans).

The testing of the scavenger composition was done in away similar to that of Examples 1-14. The dosage of the scavenger composition was 1500 g/T. The measurements of the hydrogen sulfide content and the methyl and ethyl mercaptans content (RSH) in this example were taken at 180 min (result: H₂S, less than 0.5 ppm; RSH, 9 ppm). The temperature of the petroleum in this example was +75° C.

### Example 21

The preparation of the solution of the scavenger composition was done in a way similar to that described above in Examples 1, 2 and 7-20. A scavenger composition was obtained having: sodium nitrite (15.4 wt. %), piperidine (3.9 wt. %), FeSO₄ (ferrous sulfate) (0.47 wt. %), sodium hydroxide (7.34 wt. %), and the remainder being water. This scavenger composition was used for the neutralization of hydrogen sulfide and mercaptans in the petroleum sample with a content of hydrogen sulfide of 39 ppm, and a content of methyl and ethyl mercaptans (RSH) of 398 ppm (combined for methyl and ethyl mercaptans).

The testing of the scavenger composition was done in away similar to that of Examples 1-14. The dosage of the scavenger composition was 1500 g/T. The measurements of the hydrogen sulfide content and the methyl and ethyl mercaptans content (RSH) in this example were taken at 6 hours (result: H₂S, less than 0.5 ppm; RSH, 53 ppm). The temperature of the petroleum in this example was +42° C.

The results of Example 21 as compared to those of Example 19 show that the presence of a transition metal not in a high oxidation state does not give the same effect as the presence of a transition metal in a high oxidation state.

### Example 22

The preparation of the solution of the scavenger composition was done in a way similar to that described above in Examples 1-15. A scavenger composition was obtained having: sodium nitrite (20.5 wt. %), methyl diethanolamine (10.8 wt. %), Merox catalyst (0.8 wt. %), sodium hydroxide (7.34 wt. %), and the remainder being water. This scavenger composition was used for the neutralization of hydrogen sulfide and mercaptans in the petroleum sample with a content of hydrogen sulfide of 39 ppm, and a content of methyl and ethyl mercaptans (RSH) of 398 ppm (combined for methyl and ethyl mercaptans).

The testing of the scavenger composition was done in away similar to that of Examples 1-14. The dosage of the scavenger composition was 1500 g/T. The measurements of the hydrogen sulfide content and the methyl and ethyl mercaptans content (RSH) in this example were taken at 5 hours (result: H₂S, less than 0.5 ppm; RSH, 31 ppm). The temperature of the petroleum in this example was +51° C.

### Example 23

The preparation of the solution of the scavenger composition was done in a way similar to that described above in Examples 1-15. A scavenger composition was obtained having: sodium nitrite (20.5 wt. %), dimethylethanolamine (8.1 wt. %), Merox catalyst (0.8 wt. %), sodium hydroxide (9.2 wt. %), and the remainder being water. This scavenger composition was used for the neutralization of hydrogen sulfide and mercaptans in the petroleum sample with a content of hydrogen sulfide of 39 ppm, and a content of methyl and ethyl mercaptans (RSH) of 398 ppm (combined for methyl and ethyl mercaptans).

The testing of the scavenger composition was done in away similar to that of Examples 1-14. The dosage of the scavenger composition was 1500 g/T. The measurements of the hydrogen sulfide content and the methyl and ethyl mercaptans content (RSH) in this example were taken at 5 hours (result: H₂S, less than 0.5 ppm; RSH, 19 ppm). The temperature of the petroleum in this example was +51° C.

### Example 24

The preparation of the solution of the scavenger composition was done in a way similar to that described above in Examples 1-16. A scavenger composition was obtained having: sodium nitrite (25.6 wt. %), monoethanolamine (6.1 wt. %), CuEDTA (complex of copper (+2) and EDTA) (0.87 wt. %), sodium hydroxide (12.0 wt. %), and the remainder being water. This scavenger composition was used for the neutralization of hydrogen sulfide and mercaptans in the petroleum sample with a content of hydrogen sulfide of 39 ppm, and a content of methyl and ethyl mercaptans (RSH) of 398 ppm (combined for methyl and ethyl mercaptans).

The testing of the scavenger composition was done in away similar to that of Examples 1-14, with the exception of the mixing conditions—no mixing was done in this Example 24. The dosage of the scavenger composition was 920 g/T. The testing was done on two samples in two different cases, (A) and (B). The difference between the two different cases (A) and (B) was the treatment temperature. The other parameters—the dosage and the mixing conditions—were identical. In case (A), the measurements of the hydrogen sulfide content and the methyl and ethyl mercaptans content (RSH) were taken at 8 hours (result: H₂S, less than 0.5 ppm; RSH, 34 ppm). The temperature of the petroleum in this case (A) was +23° C. In case (B), the measurements of the hydrogen sulfide content and the methyl and ethyl mercaptans content (RSH) were taken at 30 hours (result: H₂S, less than 0.5 ppm; RSH, 8 ppm). The temperature of the petroleum in this case (A) was +4° C.

The results of Examples 24 (A) and (B) demonstrate the possibility of employing the scavenging method of the present invention at lowered temperatures for scavenging of hydrogen sulfide and mercaptans. It simulates a situation of treatment in temporary storage tanks at lowered environmental temperatures.

### Example 25

The preparation of the solution of the scavenger composition was done in a way similar to that described above in Examples 1-17. A scavenger composition was obtained having: sodium nitrite (6.54 wt. %), monoethanolamine (23.2 wt. %), CuEDTA (complex of copper (+2) and EDTA) (0.23 wt. %), sodium hydroxide (3.1 wt. %) and the remainder being water. This scavenger composition was used for the neutralization of hydrogen sulfide and mercaptans in the petroleum sample with a content of hydrogen sulfide of 39 ppm, and a content of methyl and ethyl mercaptans (RSH) of 398 ppm (combined for methyl and ethyl mercaptans).

The testing of the scavenger composition was done in away similar to that of Examples 1-14, with the exception of the mixing conditions—no mixing was done in this Example 25. The dosage of the scavenger composition was 3600 g/T. The measurements of the hydrogen sulfide content and the methyl and ethyl mercaptans content (RSH) in this example were taken at 8 hours (result: H₂S, less than 0.5 ppm; RSH, 28 ppm). The temperature of the petroleum in this example was +23° C.

The results of Example 25 as compared to those of Example 24 (A) show that increasing the fraction of the nitrogen-containing scavenger (amine in this example) beyond the preferred molar limits does not produce a significant improvement in the quality of the treatment.

### Example 26

The preparation of the solution of the scavenger composition was done in a way similar to that described above in Examples 1-18. A scavenger composition was obtained having: sodium nitrite (25.6 wt. %), monoethanolamine (6.1 wt. %), CuEDTA (complex of copper (+2) and EDTA) (0.44 wt. %), sodium hydroxide (12.0 wt. %), and the remainder being water. This scavenger composition was used for the neutralization of hydrogen sulfide and mercaptans in the petroleum sample with a content of hydrogen sulfide of 39 ppm, and a content of methyl and ethyl mercaptans (RSH) of 398 ppm (combined for methyl and ethyl mercaptans).

The testing of the scavenger composition was done in away similar to that of Examples 1-14, with the exception of the mixing conditions—no mixing was done in this Example 26. The dosage of the scavenger composition was 920 g/T. The measurements of the hydrogen sulfide content and the methyl and ethyl mercaptans content (RSH) in this example were taken at 8 hours (result: H₂S, less than 0.5 ppm; RSH, 91 ppm). The temperature of the petroleum in this example was +23° C.

The results of Example 26 as compared to those of Example 24 (A) show that decreasing the fraction of the transition metal in a high oxidation state below the preferred limits worsens the quality of the treatment.

### Example 27

The preparation of the solution of the scavenger composition was done in a way similar to that described above in Examples 1-18, with the exception that two nitrogen-containing scavengers (amine compounds) were used: piperidine and dimethylethanolamine (DMEA). They were added to the solution as usual in succession after the dissolving of the dry components. A scavenger composition was obtained having: sodium nitrite (24.1 wt. %), piperidine (1.98 wt. %), DMEA (8.3 wt. %), oxyvanadium phthalocyanine catalyst (0.56 wt. %), sodium hydroxide (14.0 wt. %), and the remainder being water. This scavenger composition was used for the neutralization of hydrogen sulfide and mercaptans in viscosity breaking petroleum—fraction N.K.—180° C. This was a distillate of viscosity breaking tar products. The content of hydrogen sulfide was 10 ppm, and the content of methyl and ethyl mercaptans was 1250 ppm (combined for methyl and ethyl mercaptans). The total sulfur content was 1.49 wt. %.

The fraction without treatment did not pass the copper plate test (class 3B). This fraction is usually characterized by a high content of total sulfur (usually up to 2%) and a high content of olefins—iodine number is usually up to 50 g iodine per 100 g of product. The fraction is unstable, and after treatment by the method of sweetening with the use of oxygen, gel-like agglomerates form. The agglomerates are polycondensation products of oxiranes (epoxides), which are formed as a result of oxidation of unsaturated hydrocarbons by the oxygen of air in the presence of sweetening catalysts. In contrast, scavenging with the method of the present invention did not produce such unwanted agglomeration by-products, and the fraction after such treatment passed the copper strip corrosion test (class 1A). The copper testing was done per Standard Test Method for Copper Strip Corrosion by Liquefied Petroleum (LP) Gases, ASTM Standard D 1838-91; American Society for Testing and Materials: West Conshohocken, Pa., 1991 (Reapproved 2001), p 1.

The testing of the scavenger composition was done in away similar to that of Examples 1-16. The dosage of the scavenger composition was 2820 g/T. The measurements of the hydrogen sulfide content and the methyl and ethyl mercaptans content (RSH) in this example were taken at 8 hours (result: H₂S, less than 0.5 ppm; RSH, 19 ppm). The temperature of the petroleum in this example was +60° C.

The results of Example 27 demonstrate the use of a mixture of nitrogen-containing scavengers—in this case, amines (piperidine added in a ratio of 1 mole to 60 moles of sulfur, DMEA added in a ratio of 1 mole to 15 moles of sulfur). Thus, the molar ratio of the amines (combined) to the sulfur is 1 mole of amine group nitrogen to 12 moles of sulfur.

TABLE 1

| Ex. | C1 | C2 | C3 | C4 | C5 | C6 |
|---|---|---|---|---|---|---|
| 1 | NaNO₂, | diethanolamine, | — | NaOH, | 750 g/T | Temperature t = +35° C. |
| | 3 moles, | 25 moles, | | 8 moles, | | Treatment time [symbol] = 90 min |
| | 24.3% | 4.45% | | 5.3% | | Result = 45 ppm |
| | | | | | | Treatment time [symbol] = 150 |
| | | | | | | min |
| | | | | | | Result less than 0.5 ppm |
| 2 | NaNO₂, | monoethanolamine | — | NaOH, | 750 g/T | Temperature t = +35° C. |
| | 3 moles, | (MEA) triazine | | 8 moles, | | Treatment time [symbol] = 90 min |
| | 24.3% | 25 moles, | | 5.3% | | Result = 37 ppm |
| | | 3.1% | | | | Treatment time [symbol] = 150 |
| | | | | | | min |
| | | | | | | Result less than 0.5 ppm |
| 3 | NaNO₂, | — | — | — | 750 g/T | Temperature t = +35° C. |
| | 2 moles, | | | | | Treatment time [symbol] = 90 min |
| | 36.5% | | | | | Result = 191 ppm |
| | | | | | | Treatment time [symbol] = 150 |
| | | | | | | min |
| | | | | | | Result = 162 ppm |
| 4 | — | monoethanolamine | | | 750 g/T | Temperature t = +35° |
| | | (MEA) triazine | | | | Treatment time [symbol] = 90 min |
| | | 2 moles (per 1 mole | | | | Result = 211 ppm |
| | | of nitrogen) | | | | Treatment time [symbol] = 150 |
| | | 38.63% | | | | min |
| | | | | | | Result = 197 ppm |
| 5 | — | — | — | NaOH, | 750 g/T | Temperature t = +35° C. |
| | | | | 2 moles, | | Treatment time [symbol] = 90 min |
| | | | | 21.2% | | Result =195 ppm |
| | | | | | | Treatment time [symbol] = 150 |
| | | | | | | min |
| | | | | | | Result =192 ppm |
| 6 | — | diethanolamine, | — | — | 750 g/T | Temperature t = +35° C. |
| | | 2 moles , | | | | Treatment time [symbol] = 90 min |
| | | 55.64% | | | | Result = 173 ppm |
| | | | | | | Treatment time [symbol] = 150 |
| | | | | | | min |
| | | | | | | Result = 142 ppm |
| 7 | NaNO₂, | diethanolamine, | catalyst | NaOH | 750 g/T | Temperature t = +35° C. |
| | 3 moles, | 25 moles, | MEROX, | 8 moles, | | Treatment time [symbol] = 90 min |
| | 24.3% | 4.45% | 900 | 5.3% | | Result = 12 ppm |
| | | | moles, | | | Treatment time [symbol] = 120 |
| | | | 1% | | | min |
| | | | | | | Result less than 0.5 ppm |
| 8 | NaNO₂, | diethanolamine, | catalyst | NaOH, | 750 g/T | Temperature t = +35° C. |
| | 3 moles, | 25 moles, | MEROX, | 8 moles, | | Treatment time [symbol] = 90 min |
| | 24.3% | 4.45% | 1200 | 5.3% | | Result = 44 ppm |
| | | | moles, | | | Treatment time [symbol] = 150 |
| | | | 0.75 % | | | min |
| | | | | | | Result less than 0.5 ppm |
| 9 | NaNO₂, | monoethanolamine, | — | — | 770 g/T | Temperature t = +40° C. |
| | 2 moles, | 6 moles, | | | | Treatment time [symbol] = 90 min |
| | 35.6% | 10.5 % | | | | Result = 34 ppm |
| | | | | | | Treatment time [symbol] = 150 |
| | | | | | | min |
| | | | | | | Result = 3 ppm |
| 10 | NaNO₂, | monoethanolamine, | — | — | 1402 g/T | Temperature t = +40° C. |
| | 1 mole, | 6 moles, | | | | Treatment time [symbol] = 90 min |
| | 39.0% | 5.25% | | | | Result = 31 ppm |
| | | | | | | Treatment time [symbol] = 150 |
| | | | | | | min |
| | | | | | | Result less than 2.5 ppm |
| 11 | [Solution | [Solution B] | — | — | Solution | Temperature t = +40° C. |
| | A] | monoethanolamine, | | | A = 770 | Treatment time [symbol] = 90 min |
| | NaNO₂, | 12 moles, 27.3% | | | g/T, | Result = 28 ppm |
| | 2 mole, | monoethanolamine | | | Solution | Treatment time [symbol] = 150 |
| | 35.5% | (MEA) triazine | | | B = 148 | min |
| | | 12 moles, 32.6% | | | g/T | Result less than 1.5 ppm |
| 12 | NaNO₂, | PEPA, | — | KOH, | 640 g/T | Temperature t = −5° C. |
| | 4 moles, | 7 moles, | CuEDTA | 15 moles, | | Treatment time [symbol] = 22 |
| | 20.8% | 13.6% | (complex | 4.6% | | hours |
| | | | of copper | | | Result = 59 ppm |
| | | | and | | | Treatment time [symbol] = 36 |
| | | | EDTA), | | | hours |
| | | | 400 | | | Result less than 0.5 ppm |
| | | | moles, | | | |
| | | | 1.1% | | | |
| 13 | KNO₂, | aminoethyl | FeEDTA | NaOH, | 700 g/T | Temperature t = +35° C. |
| | 4 moles, | piperazine, | (complex | 10 moles, | | Treatment time [symbol] = 150 |
| | 24.1% | 7 moles, | of iron | 4.5% | | min |
| | | 7.0% | and | | | Result = 31 ppm |
| | | | EDTA), | | | Treatment time [symbol] = 240 |
| | | | 300 | | | min |
| | | | moles, | | | Result = 2.5 ppm |
| | | | 1.2% | | | |
| 14 | KNO₂, | aminoethyl | FeEDTA | NaOH | 700 g/T | Temperature t = +35° C. |
| | 4 moles, | piperazine, | (complex | 10 moles, | | Treatment time [symbol] = 240 |
| | 24.1% | 49 moles, | of iron | 4.5% | | min |
| | | 1.0% | and | | | Result = 124 ppm |
| | | | EDTA), | | | |
| | | | 300 | | | |
| | | | moles, | | | |
| | | | 1.2% | | | |
| 15 | NaNO₂, | aminoethyl | MnEDTA | NaOH | 500 g/T | Temperature t = +35° C. |
| | 4 moles, | ethanolamine, | (complex | 20 moles, | | Treatment time [symbol] = 150 |
| | 27.4% | 14 | of | 3.2% | | min |
| | | 5.9% | manganese | | | Result = 47 ppm |
| | | | and | | | Treatment time [symbol] = 240 |
| | | | EDTA) | | | min |
| | | | 400 | | | Result = 12 ppm |
| | | | moles, | | | |
| | | | 0.7% | | | |
| 16 | KNO₂, | ethylene diamine | catalyst | NaOH, | 670 g/T | Temperature t = +23° C. |
| | 4 moles, | 10 moles | MEROX, | 15 moles, | | Treatment time [symbol] = 240 |
| | 25.0% | 3.6% | 1000 | 3.13% | | min |
| | | | moles, | | | Result = 38 ppm |
| | | | 0.67% | | | Treatment time [symbol] = 300 |
| | | | | | | Result = 6 ppm |
| 17 | KNO₂, | ethylene diamine | catalyst | NaOH, | 670 g/T | Temperature t = +23° C. |
| | 4 moles, | 10 moles | MEROX, | 15 moles, | | Treatment time [symbol] = 240 |
| | 25.0% | 3.6% | 1000 | 3.13% | | min |
| | | | moles, | | | Result = 3 ppm |
| | | | 0.67% | | | |
| 18 | KNO₂, | piperazine (two | — | NaOH | 670 g/T | Temperature t = +55° C. |
| | 4 moles, | secondary amino | | 15 moles, | | Treatment time [symbol] = 120 |
| | 25.0% | groups), | | 3.13% | | min |
| | | 4 moles, | | | | Result = 2 ppm |
| | | 12.8% | | | | Temperature t = +5° C. |
| | | | | | | Treatment time [symbol] = 20 |
| | | | | | | hours |
| | | | | | | Result = 2 ppm |
| | | | | | | Temperature t = −5° C. |
| | | | | | | Treatment time [symbol] = 32 |
| | | | | | | hours |
| | | | | | | Result = 4 ppm |
| 19 | NaNO₂, | Piperidine, | FeEDTA | NaOH, | 1500 g/T | Temperature t = +42° C. |
| | 4 moles, | 20 moles, | (complex | 5 moles, | | Treatment time [symbol] = 6 |
| | 15.4% | 3.9% | of iron | 7.34% | | hours |
| | | | and | | | Result: H₂S ≤ 0.5 ppm, |
| | | | EDTA), | | | RSH = 24 ppm |
| | | | 300 | | | |
| | | | moles, | | | |
| | | | 1.13% | | | |
| 20 | NaNO₂, | piperidine, | Merox | NaOH, | 1500 g/T | Temperature t = +75° C. |
| | 2 moles, | 20 moles, | 1000 | 5 moles, | | Treatment time [symbol] = 180 |
| | 30.7% | 3.9% | moles, | 7.34% | | min |
| | | | 0.8% | | | Result: H₂S ≤ 0.5 ppm, |
| | | | | | | RSH = 9 ppm |
| 21 | NaNO₂, | piperidine, | FeSO₄ | NaOH, | 1500 g/T | Temperature t = +42° C. |
| | 4 moles, | 20 moles, | (iron | 5 moles, | | Treatment time [symbol] = 6 hours |
| | 15.4% | 3.9% | sulfate), | 7.34% | | Result: H₂S ≤ 0.5 ppm, |
| | | | 300 | | | RSH = 53 ppm |
| | | | moles, | | | |
| | | | 0.47% | | | |
| 22 | NaNO₂, | methyl | Merox | NaOH, | 1500 g/T | Temperature t = +51° C. |
| | 3 moles, | diethanolamine, | 1000 | 5 moles | | Treatment time [symbol] = 5 |
| | 20.5% | 10 moles, | moles, | 7.34% | | hours |
| | | 10.8% | 0.8% | | | Result: H₂S ≤ 0.5 ppm, |
| | | | | | | RSH = 31 ppm |
| 23 | NaNO₂, | Dimethylethanol- | Merox | NaOH, | 1500 g/T | Temperature t = +51° C. |
| | 3 moles, | amine, | 1000 | 4 moles, | | Treatment time [symbol] = 5 |
| | 20.5% | 10 moles, | moles, | 9.2% | | hours |
| | | 8.1% | 0.8% | | | Result: H₂S ≤ 0.5 ppm, |
| | | | | | | RSH = 19 ppm |
| 24 | NaNO₂, | monoethanolamine, | CuEDTA | NaOH, | 920 g/T | (A) Temperature t = +23° C. |
| | 4 moles, | 15 moles, | (complex | 5 moles, | | Treatment time [symbol] = 8 hours |
| | 25.6% | 6.1% | of copper | 12% | | Result: H₂S ≤ 0.5 ppm, |
| | | | and | | | RSH = 34 ppm |
| | | | EDTA), | | | (B) Temperature t = +4° C. |
| | | | 600 | | | Treatment time [symbol] = 30 |
| | | | moles, | | | hours |
| | | | 0.87% | | | Result: H₂S ≤ 0.5 ppm, |
| | | | | | | RSH = 8 ppm |
| 25 | NaNO₂, | monoethanolamine, | CuEDTA | NaOH, | 3600 g/T | Temperature t = +23° C. |
| | 4 moles, | 1 mole, | (complex | 5 moles, | | Treatment time [symbol] = 8 hours |
| | 6.54% | 23.2% | of copper | 3.1% | | Result: H2S ≤ 0.5 ppm, |
| | | | and | | | RSH = 28 ppm |
| | | | EDTA), | | | |
| | | | 600 | | | |
| | | | moles, | | | |
| | | | 0.23% | | | |
| 26 | NaNO₂, | monoethanolamine, | CuEDTA | NaOH, | 920 g/T | Temperature t = +23° C. |
| | 4 moles, | 15 moles, | (complex | 5 moles, | | Treatment time [symbol] = 8 hours |
| | 25.6% | 6.1% | of copper | 12% | | Result: H2S ≤ 0.5 ppm, |
| | | | and | | | RSH = 91 ppm |
| | | | EDTA), | | | |
| | | | 1200 | | | |
| | | | moles, | | | |
| | | | 0.44% | | | |
| 27 | NaNO₂, | Oxyvanadium | piperidine | NaOH | 2820 g/T | Temperature t = +60° C. |
| | 4 moles, | 60 moles, 1.98%, | phthalo- | 4 moles | | Treatment time [symbol] = 8 hours |
| | 24.1% | DMEA | cyanine | 390 g, | | Result: H2S ≤ 0.5 ppm, |
| | | 15 moles, 8.3% | 500 | 14.0% | | RSH = 19 ppm |
| | | | moles, | | | |
| | | | 0.56% | | | |

### Example 28

In this example, the solution of the scavenger composition of Example 27 was used for the scavenging of hydrogen sulfide and mercaptans from associated petroleum gas to meet the requirements of Russian standard STO Gazprom 089-2010 for a main pipeline (which is hydrogen sulfide up to 0.007 g/m³ and mercaptans up to 0.016 g/m³). A glass packed absorber with a diameter of 20 mm and a height of 500 mm was used, and 40 ml of the solution of the scavenger composition of Example 27 was poured into it. The absorber was packed with glass Raschig rings of size 5×5×1 mm. After this, at room temperature and atmospheric pressure, methane containing 0.62 g/m³ of hydrogen sulfide and 1.2 g/m³ of methyl mercaptan was passed through the absorber at a volume rate of 40 m³/hr. The initial gas and the scavenged gas at the top were assayed for the content of hydrogen sulfide and methyl mercaptan by the chromatography method of Russian standard GOST R 53367-2009. The gas sample was taken after 1 hour and after 10 hours. The content of hydrogen sulfide and mercaptans in the gas at the exit from the absorber was trace amounts. No frothing of the scavenger composition or formation of solid reaction products was observed. Thus, the scavenger composition is suitable for scavenging of both liquid and gaseous hydrocarbons.

### Example 29

In this example, the solution of the scavenger composition of Example 3 was used for the scavenging of hydrogen sulfide and mercaptans from associated petroleum gas. The conditions for performance of this example were similar to those of Example 28 discussed above, and again 40 ml of the solution of the scavenger composition was used. The gas sample was taken after 1 hour and after 10 hours. After 1 hour, in the gas at the exit from the absorber, the content of hydrogen sulfide was none, and the content of methyl mercaptan was 1.02 g/m³. After 10 hours, in the gas at the exit from the absorber, the content of hydrogen sulfide was 0.01 g/m³, and the content of methyl mercaptan was 1.14 g/m³. Thus, in this example the scavenged gas did not meet the requirements of the Russian standard STO Gazprom 089-2010.

Thus, the results of Examples 28 and 29 demonstrate the possibility of using the scavenger composition and method of the present invention for scavenging in gaseous media.

### Example 30

In this example, the solution of the scavenger composition of Example 17 was used for the scavenging of hydrogen sulfide from furnace fuel—a mixture of the heavy gas oil of catalytic cracking gas (75%) and the Diesel fraction (25%)—with a content of hydrogen sulfide of 27 ppm. The testing of the scavenger composition was done in a way similar to that of Examples 1-14. The dosage of the scavenger composition was 130 g/T. The measurement of the hydrogen sulfide content in this example was taken at 2 hours per Russian standard GOST R 53716-2009 (IP 399/94), and the result was less than 0.5 ppm of H₂S. The temperature of the raw material in this example was +60° C.

### Example 31

In this example, the solution of the scavenger composition of Example 27 was used for the scavenging of hydrogen sulfide from model fuel—hydrotreated kerosene fraction—a component of winter Diesel fuel with artificially introduced hydrogen sulfide. The content of hydrogen sulfide in the kerosene fraction was 1742 ppm. The content of residual total sulfur in the form of thiophene prior to the addition of the hydrogen sulfide in the hydrotreated kerosene was 7 ppm. For the addition of hydrogen sulfide to the hydrotreated fraction, the known method of bubbling gaseous hydrogen sulfide through a layer of kerosene was used. Thus, the total content of sulfur in the kerosene together with the hydrogen sulfide was 1749 ppm. The measurement of the hydrogen sulfide was done by the standard chromatography technique per Russian standard GOST 33690-2015, while measurement of the total sulfur was done by the standard technique per Russian standard GOST R 51947-2002 (ASTM D 4294-98) on the “SPEKTROSCAN-SUL” instrument.

The testing of the scavenger composition was done in away similar to that of Examples 1-14. The dosage of the scavenger composition was 5440 g/T. The measurement of the hydrogen sulfide content in this example was taken at 3 hours (result was less than 0.5 ppm of H₂S). The temperature of the raw material in this example was +23° C.

After the treatment, in order to wash kerosene from residual particles of the spent scavenger, in the flask containing 96 g of kerosene, 10.7 ml of distilled water was poured and this was mixed on a mixer for 10 minutes, after which the water phase was separated from the hydrocarbon phase using a separating funnel. As a result, a clear solution with characteristic yellow coloration and no visible solid particles was produced. This aqueous solution was assayed for the presence of sulfide ions SH¹⁻ and S²⁻ by first converting them to organic 1-pentanethiol and diamyl sulfide, respectively, through reactions with 1-bromopentane (0.5 hr, 60-70° C.) followed by chromatography analysis of these two organic sulfur compounds. According to the chromatography data, a group of diorganyl polysulfides formed. However, no 1-pentanethiol and diamyl sulfide were detected indicating that the aqueous phase did not contain SH¹⁻ and S²⁻ ions.

An assay of the hydrocarbon phase for the total sulfur content showed 7 ppm. Thus, all the sulfur-containing compounds originally present in the kerosene have been scavenged into the scavenger composition aqueous phase where H₂S has been converted into other sulfur forms and no longer exists as sulfide ions. In other words, the kerosene after treatment with the scavenger composition of the present invention was not contaminated with sulfur-containing reaction products, which have been passed into the aqueous phase without recombinant hydrogen sulfide.

The results of Example 31 show that the products of the reaction of the scavenger composition of the present invention and hydrogen sulfide form water-soluble compounds, which do not contaminate the raw material and are easily removed from the reaction zone together with the formation water (oil produced waters).

### Example 32

In this example, the solution of the scavenger composition of Example 27 was used for the scavenging of mercaptans from model fuel—hydrotreated kerosene fraction—a component of winter Diesel fuel with artificially introduced amyl mercaptan (pentane thiol). The content of amyl mercaptan in the kerosene fraction was 1700 ppm. Just as in Example 31 above, the content of residual total sulfur in the form of thiophenes prior to the addition of the hydrogen sulfide in the hydrotreated kerosene was 7 ppm. Thus, the total content of sulfur in the kerosene together with the hydrogen sulfide was 1707 ppm. The measurement of the hydrogen sulfide was done by the potentiometer technique per Russian standard GOST R 52030-2003 (ASTM D 3227-99), while the measurement of the total sulfur was done by the standard technique per Russian standard GOST R 51947-2002 (ASTM D 4294-98) on the “SPEKTROSCAN-SUL” instrument.

The testing of the scavenger composition was done in away similar to that of Examples 1-14. The dosage of the scavenger composition was 5400 g/T. The measurement of the mercaptans content in this example was taken at 5 hours (result was mercaptans were absent). The temperature of the raw material in this example was +65° C.

Just as in Example 31 above, after the treatment in a flask containing 96 g of kerosene, there was poured 10.7 ml of distilled water and this was mixed on a mixer for 10 minutes, after which the water phase was separated from the hydrocarbon phase using a separating funnel. The sulfide ions (SH¹⁻ and S²⁻) in the aqueous phase were assayed using the same protocol as described above in Example 31, and were found to be absent.

Meanwhile, the measurement of the total sulfur content of the scavenged kerosene on the “SPEKTROSCAN-SUL” instrument revealed 1707 ppm. Investigation of the sulfur organics in the treated kerosene by chromatography showed a new peak of diamyl disulfide. Thus, the reaction of neutralization of mercaptans as described in this example occurs with the formation of organic disulfides, not soluble in water, as in the sweetening type processes.

The results of Example 32 show that the products of the reaction of the scavenger composition of the present invention and mercaptans form water-insoluble organic disulfides. Thus, the neutralization reaction of mercaptans by the method of the present invention occurs with formation of organic disulfides, i.e., the same result as the mercaptan sweetening processes (i.e., Merox sweetening).

There are further embodiments of the scavenger composition of the present invention for scavenging hydrogen sulfide and mercaptans in any hydrocarbon media, including a gaseous hydrocarbon medium. For example, four further embodiments of an aqueous solution of the scavenger composition of the present invention for use in scavenging hydrogen sulfide and mercaptans in any hydrocarbon media, including a gaseous hydrocarbon medium, comprise the following components as listed below in Table 2. These further embodiments may be produced in a manner similar to the production methods as described above in the preceding Examples.

TABLE 2

| | methyl- | triethanolamine | | potassium |
|---|---|---|---|---|
| embod- | diethanolamine | (TEA) | nitrite | hydroxide |
| iment: | (MDEA) (wt. %) | (wt. %) | (wt. %) | (wt. %) |
| 1 | 7% | 2% | 20% (sodium | 6% |
| | | | nitrite) | |
| 2 | 7% | 2% | 20% | 6% |
| | | | (potassium | |
| | | | nitrite) | |
| 3 | 7% | 2% | 18% (sodium | 8% |
| | | | nitrite) | |
| 4 | 7% | 2% | 18% | 10% |
| | | | (potassium | |
| | | | nitrite) | |

Further embodiments of an aqueous solution of the scavenger composition for use in scavenging hydrogen sulfide and mercaptans in any hydrocarbon media, including a gaseous hydrocarbon medium, include the relative amounts of the four embodiments listed above, but with different individual components. That is, an alternative organic nitrogen-containing scavenger(s) may be substituted for the MDEA and/or TEA listed above, an alternative alkali metal nitrite may be substituted for the sodium or potassium nitrite listed above, and an alternative inorganic base may be substituted for the potassium hydroxide listed above.

### Examples 33-38

There are also further embodiments of the scavenger composition of the present invention that are particularly suited to scavenge hydrogen sulfide and mercaptans in a gaseous hydrocarbon media. For example, six preferred embodiments of an aqueous solution of the scavenger composition of the present invention, particularly for use in scavenging hydrogen sulfide and mercaptans in a gaseous hydrocarbon media comprise the components described below in Examples 33 to 38 and as listed below in Table 3.

### Example 33

To a 2 liter plastic beaker equipped with an overhead mechanical stirrer was added sodium nitrite (200 g) and sodium hydroxide pellets (20 g) followed by 600 mL of DI water. The mixture was stirred until all the solids were dissolved. To the solution was then added N-methyldiethanolamine (70 g) and triethanolamine (20 g) in water (90 mL) and the resulted mixture was stirred until a homogenous solution was obtained. The afforded light yellow aqueous scavenger solution (1000 g) has 7% (wt) of N-methyldiethanolamine, 2% (wt) of triethanolamine, 20% of sodium nitrite, and 2% sodium hydroxide.

### Example 34

To a 2 liter plastic beaker equipped with an overhead mechanical stirrer was added sodium nitrite (180 g) and sodium hydroxide pellets (40 g) followed by 600 mL of DI water. The mixture was stirred until all the solids were dissolved. To the solution was then added N-methyldiethanolamine (70 g) and triethanolamine (20 g) in water (90 mL) and the resulted mixture was stirred until a homogenous solution was obtained. The afforded light yellow aqueous scavenger solution (1000 g) has 7% (wt) of N-methyldiethanolamine, 2% (wt) of triethanolamine, 18% of sodium nitrite, and 4% sodium hydroxide.

### Example 35

To a 2 liter plastic beaker equipped with an overhead mechanical stirrer was added sodium nitrite (160 g) and sodium hydroxide pellets (20 g) followed by 600 mL of DI water. The mixture was stirred until all the solids were dissolved. To the solution was then added N-methyldiethanolamine (120 g) and triethanolamine (20 g) in water (80 mL) and the resulted mixture was stirred until a homogenous solution was obtained. The afforded light yellow aqueous scavenger solution (1000 g) has 12% (wt) of N-methyldiethanolamine, 2% (wt) of triethanolamine, 16% of sodium nitrite, and 2% sodium hydroxide.

### Example 36

To a 2 liter plastic beaker equipped with an overhead mechanical stirrer was added sodium nitrite (140 g) and sodium hydroxide pellets (60 g) followed by 600 mL of DI water. The mixture was stirred until all the solids were dissolved. To the solution was then added N-methyldiethanolamine (10 g) and triethanolamine (120 g) in water (70 mL) and the resulted mixture was stirred until a homogenous solution was obtained. The afforded light yellow aqueous scavenger solution (1000 g) has 1% (wt) of N-methyldiethanolamine, 12% (wt) of triethanolamine, 14% of sodium nitrite, and 6% sodium hydroxide.

### Example 37

To a 2 liter plastic beaker equipped with an overhead mechanical stirrer was added sodium nitrite (160 g) followed by 580 mL of DI water. The mixture was stirred until all the solids were dissolved. To the solution was then added N-methyldiethanolamine (200 g) and triethanolamine (10 g) in water (50 mL) and the resulted mixture was stirred until a homogenous solution was obtained. The afforded light yellow aqueous scavenger solution (1000 g) has 20% (wt) of N-methyldiethanolamine, 1% (wt) of triethanolamine, and 16% of sodium nitrite.

### Example 38

To a 2 liter plastic beaker equipped with an overhead mechanical stirrer was added sodium nitrite (180 g) and potassium hydroxide pellets (44 g) followed by 600 mL of DI water. The mixture was stirred until all the solids were dissolved. To the solution was then added N-methyldiethanolamine (70 g) and triethanolamine (20 g) in water (86 mL) and the resulted mixture was stirred until a homogenous solution was obtained. The afforded light yellow aqueous scavenger solution (1000 g) has 7% (wt) of N-methyldiethanolamine, 2% (wt) of triethanolamine, 18% of sodium nitrite, and 4% potassium hydroxide.

TABLE 3

| | | | Sodium | Sodium | Potassium |
|---|---|---|---|---|---|
| | MDEA | TEA | nitrite | hydroxide | hydroxide |
| Example # | (wt. %) | (wt. %) | (wt. %) | (wt. %) | (wt. %) |
| Ex. 33 | 7% | 2% | 20% | 2% | |
| Ex. 34 | 7% | 2% | 18% | 4% | |
| Ex. 35 | 12% | 2% | 16% | 2% | |
| Ex. 36 | 1% | 12% | 14% | 6% | |
| Ex. 37 | 20% | 1% | 16% | | |
| Ex. 38 | 7% | 2% | 18% | | 4% |
| A | 28% | 2% | 20% | 2% | |
| B | 0% | 4% | 35% | 0.5% | |

Further embodiments of an aqueous solution of the scavenger composition for use in scavenging hydrogen sulfide and mercaptans in a gaseous hydrocarbon media include the relative amounts of the six preferred embodiments listed above, but with different individual components. That is, an alternative organic nitrogen-containing scavenger(s) may be substituted for the MDEA and/or TEA listed above, an alternative alkali metal nitrite may be substituted for the sodium nitrite listed above, and an alternative inorganic base may be substituted for the sodium hydroxide listed above.

### Example 39

Loading capacity tests of Ex. 34 and 1,3,5-Triazine-1,3,5(2H,4H,6H)-triethanol (MEA triazine) for H₂S with and without CO₂

The H₂S scavenging capacity of the scavenger was tested in an apparatus known as “bubble tower” made of a glass column with an internal diameter of 1.5 inch and a height of 8 inch. A feed gas comprised of 10% H₂S and 90% N₂ was continuously bubbled from the bottom of the tower that was filled with a known amount of a tested scavenger, and the exit gas from the top of the tower was analyzed using a gas chromatograph for the H₂S content. The volumetric quantity of H₂S consumed was calculated by multiplying the difference in the H₂S concentrations between the inlet and outlet gases and the gas flowrate over time. To test the effect of CO₂ which is often present in nature gases, a feed gas containing 2% CO₂, 10% H₂S and 90% N₂ was employed.

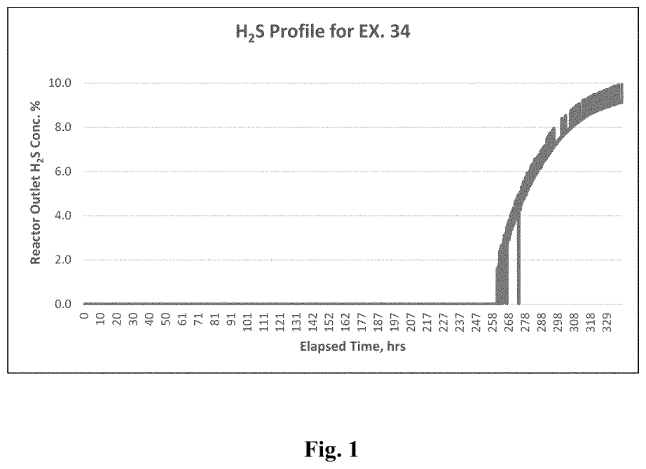

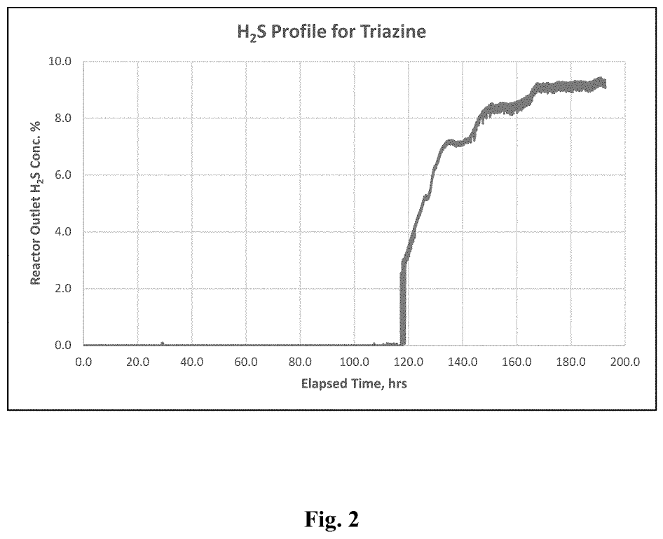

The breakthrough profiles of Ex. 34 and MEA triazine are depicted in FIGS. 1 and 2. The loading capacity of the scavengers are calculated using the following equation and the results are summarized in Table 4:

Sulfur Loading capacity:

(gram of sulfur/kg of scavenger solution)=(D*F*T*32.065)/W

Where

D=H₂S concentration difference between inlet and outlet (mol/L)

F=Gas flowrate (L/h)

T=Time to reach the breakthrough point (h)

W=Weight of tested scavenger (Kg)

Surfur (S) molecular weight=32.065 (g/mol)

TABLE 4
Loading capacity with and without CO₂ (gS/kg solvent)

| Scavenger | Without CO₂ | With CO₂ |
|---|---|---|
| Ex. 33 | 1293 | |
| Ex. 34 | 1383 | 1042 |
| Ex. 35 | 1050 | |
| Ex. 37 | 1121 | |
| Ex. 38 | | 1030 |
| MEA triazine (50%) | 688 | 525 |

In the H₂S loading or scavenging capacity tests (Table 4), the formulations in disclosed herein are superior to industrial standard MEA triazine when tested either with or without CO₂ presence. For example, in direct head-to-head tests, Ex. 34 formulation displaced a loading capacity of 1383 g of sulfur per kg of solvent which is about 2 times of that of MEA triazine (688 gS/kg solvent). Similarly, Ex 34 formulation was able to scavenge twice as much H₂S as compared to MEA triazine in the presence of CO₂ (1042 gS/kg solvent and 525 gS/kg solvent, respectively).

In an embodiment of the present invention, the aqueous solution as described in any one of the above embodiments of the method of the present invention is used at a dosage in the range of 500 to 2,820 grams (g) per metric ton (T) of the non-gaseous hydrocarbon raw material being treated, and preferably in the range of 750 to 1,500 g/T of the non-gaseous hydrocarbon raw material being treated.

The aqueous solutions as described in each of the above embodiments of the present invention can comprise the recited components (i.e., at least one alkali metal nitrite, at least one organic nitrogen-containing scavenger, and (optionally) at least one inorganic base) in the specified amounts and/or ratios. The aqueous solutions as described in each of the above embodiments of the present invention can consist essentially of the recited components (i.e., at least one alkali metal nitrite, at least one organic nitrogen-containing scavenger, and (optionally) at least one inorganic base) in the specified amounts and/or ratios (in addition to water). The aqueous solutions as described in each of the above embodiments of the present invention can consist of the recited components (i.e., at least one alkali metal nitrite, at least one organic nitrogen-containing scavenger, and (optionally) at least one inorganic base) in the specified amounts and/or ratios (in addition to water).

In an embodiment of the present invention, the aqueous solution as described in any one of the above embodiments of the present invention does not include a polysulfide.

The foregoing examples and description should betaken as illustrating, rather than limiting. As will be readily appreciated, numerous variations and combinations of the features set forth above can be utilized without departing from the present invention as set forth in the claims.

What is claimed is:

1. A method for scavenging a sulfur-containing compound contained in a hydrocarbon medium, wherein the sulfur-containing compound is hydrogen sulfide, a mercaptan or a combination thereof, the method comprising:
contacting the hydrocarbon medium with an aqueous solution comprising:
from 10 to 25 wt. % of an alkali metal nitrite selected from the group consisting of sodium nitrite, potassium nitrite, and combinations thereof,
from 5 to 25 wt. % of at least one organic nitrogen-containing scavenger comprising di-alcohol amines, tri-alcohol amines, or a combination thereof, and
from 1 to 10 wt. % of an alkali metal hydroxide.

2. The method of claim 1, wherein the at least one organic nitrogen-containing scavenger is selected from the group consisting of diethanolamine (DEA); N-methyldiethanolamine (MDEA); triethanolamine (TEA); dimethanolamine; trimethanolamine; dipropanolamine; tripropanolamine; and combinations thereof.

3. The method of claim 1, wherein the organic nitrogen-containing scavenger is a combination of a di-alcohol amine and a tri-alcohol amine.

4. The method of claim 3, wherein the organic nitrogen-containing scavenger comprises N-methyldiethanolamine (MDEA) and triethanolamine (TEA).

5. A scavenger composition comprising:
from 10 to 25 wt. % of an alkali metal nitrite selected from the group consisting of sodium nitrite, potassium nitrite, and combinations thereof,
from 5 to 25 wt. % of at least one organic nitrogen-containing scavenger comprising di-alcohol amines, tri-alcohol amines, or a combination thereof,
from 1 to 10 wt. % of an alkali metal hydroxide, and
water.

6. The composition of claim 5, wherein the at least one organic nitrogen-containing scavenger is selected from the group consisting of diethanolamine (DEA); N-methyldiethanolamine (MDEA); triethanolamine (TEA); dimethanolamine; trimethanolamine; dipropanolamine; tripropanolamine; and combinations thereof.

7. The composition of claim 5, wherein the organic nitrogen-containing scavenger is a combination of a di-alcohol amine and a tri-alcohol amine.

8. The composition of claim 7, wherein the organic nitrogen-containing scavenger comprises N-methyldiethanolamine (MDEA) and triethanolamine (TEA).
